(19) United States
(12) Patent Application Publication
(10) Pub. No.: US 2016/0162984 A1
(43) Pub. Date: Jun. 9, 2016

(54) PROCESSING UNSTRUCTURED MESSAGES

(71) Applicant: Alibaba Group Holding Limited, George Town (KY)

(72) Inventor: Weiye SHEN, Hangzhou (CN)

(21) Appl. No.: 14/960,124

(22) Filed: Dec. 4, 2015

(30) Foreign Application Priority Data
Dec. 4, 2014 (CN) 201410742862.1

(51) Int. Cl. G06Q 30/06; G06F 3/0481; H04L 29/12

(52) U.S. Cl. CPC G06Q 30/0643; H04L 61/1547; G06F 3/04817

(57) ABSTRACT

A method for processing an unstructured message includes: acquiring, when a first client detects that an icon on a client interface is clicked, an icon identifier corresponding to the icon; receiving a first unstructured message inputted by a first user; organizing the icon identifier and the first unstructured message into a second unstructured message; and sending the second unstructured message to a communications server, where the communications server is configured to send the second unstructured message to a second client and save the first unstructured message in a first associated platform having a binding relationship with the communications server, and where the first associated platform is a platform configured to store structured information.

### CROSS-REFERENCE TO RELATED APPLICATION

This application claims priority to Chinese Patent Application No. 201410742862.1, filed on Dec. 5, 2014, which is incorporated herein by reference in its entirety.

### TECHNICAL FIELD

Embodiments according to the present invention relate generally to the field of information processing technologies and, in particular, to a method for processing an unstructured message, a client for processing an unstructured message, a server for processing an unstructured message, a platform for processing an unstructured message, and a system for processing an unstructured message.

### BACKGROUND

With the development of Internet technology, e-commerce technologies have been rapidly popularized, and a growing number of people conduct transaction activities on the Internet. In order to release a commodity on an e-commerce platform, a seller needs to fill in certain structured information. Generally speaking, the structured information is organized data configured to allow identification and separation of a key-value of a message. In the e-commerce platform, commodity information is structured by means of a category and an attribute. When the seller releases commodity information, the seller needs to input the information according to category and attribute requirements. The release mode is not flexible enough and the operation is both complex and time-consuming, thereby causing a lower release efficiency. Therefore, a message processing mechanism capable of achieving a rapid release of commodity information and simplifying user operation is needed.

### SUMMARY

Embodiments according to the disclosure provide, for example, a method for processing an unstructured message so as to simplify user operation and improve the efficiency of processing information for a user.

Also, embodiments according to the disclosure provide, for example, a client for processing an unstructured message, a server for processing an unstructured message, a platform for processing an unstructured message, and a system for processing an unstructured message, to implement and apply the aforementioned method.

In an embodiment, a method for processing an unstructured message includes: acquiring, when a first client detects that an icon on a client interface is clicked, an icon identifier corresponding to the icon; receiving a first unstructured message inputted by a first user; organizing the icon identifier and the first unstructured message into a second unstructured message; and sending the second unstructured message to a communications server, where the communications server is configured to send the second unstructured message to a second client and save the first unstructured message in a first associated platform having a binding relationship with the communications server, and where the first associated platform is a platform configured to store structured information, store the first unstructured message and generate a first data identifier corresponding to the first unstructured message.

In an embodiment, the step of acquiring includes: triggering a plug-in corresponding to the icon in response to detecting that the first user clicked on the icon on the client interface; and obtaining an icon identifier corresponding to the plug-in.

In an embodiment, before the step of receiving a first unstructured message inputted by a first user, the method further includes displaying the icon identifier in an input box of the first client.

In an embodiment, the method further includes: generating a binding request; sending the binding request to the communications server; receiving binding page data, returned by the communications server, corresponding to the binding request; rendering the binding page data to output a corresponding binding page; receiving first bound account information inputted by the first user in the binding page, where the first bound account information is account information registered by the first user on the first associated platform; and submitting the first bound account information to the communications server, where the communications server is configured to generate a binding relationship between account information of the first client and the first bound account information.

In an embodiment, the first client is a seller client, the second client is a buyer client, the first user is a seller, the first unstructured message is commodity information, the icon identifier is a purchase identifier, the second unstructured message is commodity information carrying the purchase identifier, and the first associated platform is an e-commerce platform.

In an embodiment, a method for processing an unstructured message includes: receiving, by a communications server, a second unstructured message sent by a first client, where the second unstructured message includes an icon identifier and a first unstructured message; sending the second unstructured message to a second client; and saving the first unstructured message in a first associated platform having a binding relationship with the communications server, where the first associated platform is a platform configured to store structured information, store the first unstructured message, and generate a first data identifier corresponding to the first unstructured message.

In an embodiment, before the step of saving the first unstructured message in a first associated platform having a binding relationship with the communications server, the method further includes: receiving, by the communications server, a binding request sent by the first client; acquiring binding page data corresponding to the binding request and returning it to the first client; receiving first bound account information submitted by the first client for the binding page data, where the first bound account information is account information registered by a first user on the first associated platform for logging onto the first client; and generating a binding relationship between account information of the first client and the first bound account information.

In an embodiment, the step of saving the first unstructured message in a first associated platform having a binding relationship with the communications server includes: generating a first synchronous message, where the first synchronous message includes the first unstructured message and the first bound account information; and sending the first synchronous message to the first associated platform, where the first associated platform is configured to store the first unstructured message, generate a first data identifier corresponding to the first unstructured message, and generate a binding relationship between the first bound account information and the first data identifier.

In an embodiment, the second unstructured message carries a user identifier of a second user, and the step of sending the second unstructured message to a second client includes: looking up, in a local database, by the communications server, address information of the second user corresponding to the user identifier of the second user; and sending the second unstructured message to the second client corresponding to the address information of the second user.

In an embodiment, before the step of sending the second unstructured message to a second client, the method further includes adding an on-click event for the second unstructured message when it is recognized an icon identifier of the second unstructured message.

In an embodiment, the first client is a seller client, the second client is a buyer client, the first user is a seller user, the second user is a buyer user, the first unstructured message is commodity information, the icon identifier is a purchase identifier, the second unstructured message is commodity information carrying the purchase identifier, and the first associated platform is an e-commerce platform.

In an embodiment, a method for processing an unstructured message includes: receiving, by a second client, a second unstructured message sent by a communications server, where the second unstructured message includes an icon identifier and a first unstructured message; displaying the second unstructured message; displaying an information fill-in page in response to detecting an on-click operation for the second unstructured message, where the information fill-in page comprises one or more control elements; receiving a control element value inputted for the control element; generating a third unstructured message in response to verification that the control element value is valid; and sending the third unstructured message to a communications server, where the communications server is configured to send the third unstructured message to a first client and save the third unstructured message in a first associated platform having a binding relationship with the communications server, and where the first associated platform is a platform configured to store structured information, store the third unstructured message, and generate a second data identifier corresponding to the third unstructured message.

In an embodiment, the second unstructured message is added with an on-click event, and the step of displaying an information fill-in page in response to detecting an on-click operation for the second unstructured message includes: triggering the on-click event in response to detecting an on-click operation for the second unstructured message; generating response parameter information corresponding to the on-click event and returning it to the communications server; receiving data of the information fill-in page sent by the communications server, where the data of the information fill-in page includes one or more control elements; and rendering the data of the information fill-in page to display the corresponding information fill-in page.

In an embodiment, the control element has a control element identifier, and the step of receiving a control element value inputted for the control element includes: generating an information invoking request, where the information invoking request comprises the control element identifier; sending the information invoking request to the communications server; and receiving the control element value, returned by the communications server, corresponding to the control element identifier.

In an embodiment, the communications server has a bound second associated platform, and the step of generating a third unstructured message when it is verified that the control element value is valid includes: generating a jump request of the second associated platform according to the control element value when it is verified that the control element value is valid; sending the jump request to the communications server, where the communications server is configured to jump to the second associated platform according to the jump request and receive response information returned by the second associated platform, where the second associated platform is configured to process the control element value and return the response information; receiving the response information sent by the communications server according to the jump request; and generating the third unstructured message if it is determined that the response information is successful response information.

In an embodiment, the first client is a seller client, the second client is a buyer client, the first unstructured message is commodity information, the icon identifier is a purchase identifier, the second unstructured message is commodity information carrying the purchase identifier, the information fill-in page is an order fill-in page, the third unstructured message is order completion information, the first associated platform is an e-commerce platform, and the second associated platform is a payment platform.

In an embodiment, a method for processing an unstructured message includes: receiving, by a communications server, a third unstructured message sent by a second client, where the third unstructured message is configured to: display the second unstructured message after the second client receives the second unstructured message; display an information fill-in page after it is detected an on-click operation for the second unstructured message; display the information fill-in page which includes one or more control elements; receive a control element value inputted for the control element; and generate, when it is verified that the control element value is valid, the second unstructured message that includes a first unstructured message and an icon identifier; saving the third unstructured message in a first associated platform having a binding relationship with the communications server, where the first associated platform is a platform configured to store structured information, store the third unstructured message and generate a second data identifier corresponding to the third unstructured message; and sending the third unstructured message to a first client.

In an embodiment, before the step of receiving the third unstructured message sent by the second client, the method further includes: receiving response parameter information returned by the second client; acquiring corresponding data of the information fill-in page according to the response parameter information, where the data of the information fill-in page includes one or more control elements; and returning the data of the information fill-in page to the client.

In an embodiment, the step of acquiring corresponding data of the information fill-in page according to the response parameter information includes: acquiring, by the communications server, first data identifier corresponding to the first unstructured message; generating a fill-in page data request according to the first data identifier; sending the fill-in page data request to the first associated platform, where the first associated platform is configured to generate data of the information fill-in page corresponding to the first data identifier according to preset page generating logic, and return the data of the information fill-in page to the communications server; receiving the data of the information fill-in page, returned by the first associated platform, corresponding to the first data identifier; and returning the data of the information fill-in page to the second client.

In an embodiment, account information of the second client has second bound account information in the first associated platform, and after the step of returning the data of the information fill-in page to the second client, the method further includes: receiving an information invoking request sent by the second client, where the information invoking request comprises a control element identifier; obtaining second bound account information corresponding to an account of the second client; sending the information invoking request and the second bound account information to the first associated platform, where the first associated platform is configured to locate a corresponding data record according to the second bound account information, and look up, from the data record, a control element value corresponding to the control element identifier; receiving the control element value, returned by the first associated platform, corresponding to the control element identifier; and returning the control element value to the second client.

In an embodiment, the step of saving the third unstructured message in a first associated platform having a binding relationship with the communications server includes: generating a second synchronous message, where the second synchronous message includes the third unstructured message and the second bound account information; and sending the second synchronous message to the first associated platform, where the first associated platform is configured to store the third unstructured message, generate a second data identifier corresponding to the third unstructured message, and generate a binding relationship between the second bound account information and the second data identifier.

In an embodiment, before the step of receiving the third unstructured message sent by the second client, the method further includes: receiving a jump request, of a second associated platform, sent by the second client; jumping to the second associated platform according to the jump request, where the second associated platform is configured to process the control element value and return response information; receiving the response information returned by the second associated platform; and sending the response information to the second client.

In an embodiment, the first client is a seller client, the second client is a buyer client, the first unstructured message is commodity information, the icon identifier is a purchase identifier, the second unstructured message is commodity information carrying the purchase identifier, the information fill-in page is an order fill-in page, the third unstructured message is order completion information, the first associated platform is an e-commerce platform, and the second associated platform is a payment platform.

In an embodiment, a method for processing an unstructured message includes: receiving, by the first associated platform, first unstructured message sent by a communications server, the first unstructured message is a message received by the communications server from a first client, where the first client has account information, and where the account information of the first client has first bound account information in the first associated platform; storing the first unstructured message and generating a first data identifier corresponding to the first unstructured message; generating a binding relationship between the first bound account information and the first data identifier; generating data of an information fill-in page according to the first data identifier; receiving a second unstructured message sent by a communications server, where the second unstructured message is the data of the information fill-in page acquired by the communications server; and after sending the data of the information fill-in page to a second client, receiving, from the second client, a message generated for the data of the information fill-in page; storing the second unstructured message and generating a second data identifier corresponding to the second unstructured message; and generating a binding relationship between the second bound account information and the second data identifier.

In an embodiment, the method further includes: receiving, by the first associated platform, a fill-in page data request sent by the communications server, where the fill-in page data request includes a first data identifier; generating the data of the information fill-in page corresponding to the first data identifier according to a preset page generating logic; and returning the data of the information fill-in page to the communications server.

In an embodiment, a client for processing an unstructured message includes: an icon identifier acquiring module, configured to acquire, in response to detecting that an icon on a client interface is clicked, an icon identifier corresponding to the icon; an unstructured message receiving module, configured to receive a first unstructured message inputted by a first user; an unstructured message generating module, configured to organize the icon identifier and the first unstructured message into a second unstructured message; and an unstructured message sending module, configured to send the second unstructured message to a communications server, where the communications server is configured to send the second unstructured message to a second client and save the first unstructured message in a first associated platform having a binding relationship with the communications server, and the first associated platform is a platform configured to store structured information, store the first unstructured message and generate a first data identifier corresponding to the first unstructured message.

In an embodiment, the icon identifier acquiring module includes: a plug-in triggering submodule, configured to trigger a plug-in corresponding to the icon when it is detected that the first user clicks on the icon on the client interface; and an identifier obtaining submodule, configured to obtain an icon identifier corresponding to the plug-in.

In an embodiment, the client further includes an identifier display module, configured to display the icon identifier in an input box of the client.

In an embodiment, the client further includes: a binding request generating module, configured to generate a binding request; a binding request sending module, configured to send the binding request to the communications server; a binding page data receiving module, configured to receive binding page data, returned by the communications server, corresponding to the binding request; a binding page display module, configured to render the binding page data to output a corresponding binding page; an account information receiving module, configured to receive first bound account information inputted by the first user in the binding page, where the first bound account information is account information registered by the first user on the first associated platform; and an account information sending module, configured to submit the first bound account information to the communications server, where the communications server is configured to generate a binding relationship between account information of the client and the first bound account information.

In an embodiment, the client is a seller client, the second client is a buyer client, the first user is a seller, the first unstructured message is commodity information, the icon identifier is a purchase identifier, the second unstructured message is commodity information carrying the purchase identifier, and the first associated platform is an e-commerce platform.

In an embodiment, a server for processing an unstructured message includes: a message receiving module, configured to receive a second unstructured message sent by a first client, where the second unstructured message includes an icon identifier and a first unstructured message; a message sending module, configured to send the second unstructured message to a second client; and a message saving module, configured to save the first unstructured message in a first associated platform having a binding relationship with a communications server, where the first associated platform is a platform configured to store structured information, store the first unstructured message and generate a first data identifier corresponding to the first unstructured message.

In an embodiment, the server further includes: a binding request receiving module, configured to receive a binding request sent by the first client; a binding page data acquiring module, configured to acquire binding page data corresponding to the binding request and return it to the first client; an account information receiving module, configured to receive first bound account information submitted by the first client for the binding page data, where the first bound account information is account information registered by a first user on the first associated platform for logging onto the first client; and a binding relationship generating module, configured to generate a binding relationship between account information of the first client and the first bound account information.

In an embodiment, the message saving module includes: a synchronous message generating module, configured to generate a first synchronous message, where the first synchronous message includes the first unstructured message and the first bound account information; and a synchronous message sending module, configured to send the first synchronous message to the first associated platform, where the first associated platform is configured to store the first unstructured message, generate a first data identifier corresponding to the first unstructured message, and generate a binding relationship between the first bound account information and the first data identifier.

In an embodiment, the second unstructured message carries a user identifier of a second user, and the message sending module includes: an address lookup submodule, configured to look up, in a local database, address information of the second user corresponding to the user identifier of the second user; and an unstructured message sending submodule, configured to send the second unstructured message to the second client corresponding to the address information of the second user.

In an embodiment, the server further includes an event adding module, configured to add an onclick event for the second unstructured message when it is recognized an icon identifier of the second unstructured message.

In an embodiment, the first client is a seller client, the second client is a buyer client, the first user is a seller user, the second user is a buyer user, the first unstructured message is commodity information, the icon identifier is a purchase identifier, the second unstructured message is commodity information carrying the purchase identifier, and the first associated platform is an e-commerce platform.

In an embodiment, a client for processing an unstructured message includes: a message receiving module, configured to receive a second unstructured message sent by a communications server, where the second unstructured message includes an icon identifier and a first unstructured message; a message display module, configured to display the second unstructured message; a page display module, configured to display an information fill-in page in response to detecting an on-click operation for the second unstructured message, where the information fill-in page comprises one or more control elements; a control element value receiving module, configured to receive a control element value inputted for the control element; a third unstructured message generating module, configured to generate a third unstructured message in response to verification that the control element value is valid; and a third unstructured message sending module, configured to send the third unstructured message to a communications server, where the communications server is configured to send the third unstructured message to a second client and save the third unstructured message in a first associated platform having a binding relationship with the communications server, and the first associated platform is a platform configured to store structured information, store the third unstructured message, and generate a second data identifier corresponding to the third unstructured message.

In an embodiment, the second unstructured message is added with an on-click event, and the page display module includes: an event triggering submodule, configured to trigger the on-click event in response to detecting an on-click operation for the second unstructured message; a response parameter information generating submodule, configured to generate response parameter information corresponding to the on-click event and return it to the communications server; a page data receiving submodule, configured to receive data of the information fill-in page sent by the communications server, where the data of the information fill-in page includes one or more control elements; and a rendering submodule, configured to render the data of the information fill-in page to display the corresponding information fill-in page.

In an embodiment, the control element has a control element identifier, and the control element value receiving module includes: an information invoking request generating submodule, configured to generate an information invoking request, where the information invoking request comprises the control element identifier; a request sending submodule, configured to send the information invoking request to the communications server; and a control element value receiving submodule, configured to receive the control element value, returned by the communications server, corresponding to the control element identifier.

In an embodiment, the communications server has a bound second associated platform, and the third unstructured message generating module includes: a jump request generating submodule, configured to generate a jump request of the second associated platform according to the control element value when it is verified that the control element value is valid; a jump request sending submodule, configured to send the jump request to the communications server, where the communications server is configured to jump to the second associated platform according to the jump request and receive response information returned by the second associated platform, and where the second associated platform is configured to process the control element value and return the response information; a response information receiving submodule, configured to receive the response information sent by the communications server according to the jump request; and a message generating submodule, configured to generate the third unstructured message when it is determined that the response information is successful response information.

In an embodiment, the first client is a seller client, the second client is a buyer client, the first unstructured message is commodity information, the icon identifier is a purchase identifier, the second unstructured message is commodity information carrying the purchase identifier, the information fill-in page is an order fill-in page, the third unstructured message is order completion information, the first associated platform is an e-commerce platform, and the second associated platform is a payment platform.

In an embodiment, a server for processing an unstructured message includes: an unstructured message receiving module, configured to: receive a third unstructured message sent by a second client, where the third unstructured message is configured to: display a second unstructured message after the second client receives the second unstructured message; display an information fill-in page after detecting an on-click operation for the second unstructured message; display the information fill-in page which comprises one or more control elements; receive a control element value inputted for the control element; and generate, when it is verified that the control element value is valid, the second unstructured message that comprises a first unstructured message and an icon identifier; an unstructured message saving module, configured to save the third unstructured message in a first associated platform having a binding relationship with the communications server, where the first associated platform is a platform configured to store structured information, store the third unstructured message and generate a first data identifier corresponding to the third unstructured message; and an unstructured message sending module, configured to send the third unstructured message to a first client.

In an embodiment, the server further includes: a parameter information receiving module, configured to receive response parameter information returned by the second client; a page data acquiring module, configured to acquire corresponding data of the information fill-in page according to the response parameter information, where the data of the information fill-in page includes one or more control elements; and a page data returning module, configured to return the data of the information fill-in page to the client.

In an embodiment, the page data acquiring module includes: a first data identifier acquiring submodule, configured to acquire a second data identifier corresponding to the first unstructured message; a page data request generating submodule, configured to generate a fill-in page data request according to the second data identifier; a request sending submodule, configured to send the fill-in page data request to the first associated platform, where the first associated platform is configured to generate data of the information fill-in page corresponding to the second data identifier according to preset page generating logic, and return the data of the information fill-in page to the communications server; a page data receiving submodule, configured to receive the data of the information fill-in page, returned by the first associated platform, corresponding to the second data identifier; and a page data sending submodule, configured to return the data of the information fill-in page to the second client.

In an embodiment, the account information of the second client has second bound account information in the first associated platform, and the server further includes: an information invoking request receiving module, configured to receive an information invoking request sent by the second client, where the information invoking request comprises a control element identifier; an account information obtaining module, configured to obtain the second bound account information corresponding to an account of the second client; an account information sending module, configured to send the information invoking request and the second bound account information to the first associated platform, where the first associated platform is configured to locate a corresponding data record according to the second bound account information, and look up, from the data record, a control element value corresponding to the control element identifier; a control element value receiving module, configured to receive the control element value, returned by the first associated platform, corresponding to the control element identifier; and a control element value sending module, configured to return the control element value to the second client.

In an embodiment, the unstructured message saving module includes: a synchronous message generating submodule, configured to generate a second synchronous message, where the second synchronous message includes the third unstructured message and the second bound account information; and a synchronous message sending submodule, configured to send the second synchronous message to the first associated platform, where the first associated platform is configured to store the third unstructured message, generate a second data identifier corresponding to the third unstructured message, and generate a binding relationship between the second bound account information and the second data identifier.

In an embodiment, the server further includes: a jump request receiving module, configured to receive a jump request, of a second associated platform, sent by the second client; a jump module, configured to jump to the second associated platform according to the jump request, where the second associated platform is configured to process the control element value and return response information; a response information receiving module, configured to receive the response information returned by the second associated platform; and a response information returning module, configured to send the response information to the second client.

In an embodiment, the first client is a seller client, the second client is a buyer client, the first unstructured message is commodity information, the icon identifier is a purchase identifier, the second unstructured message is commodity information carrying the purchase identifier, the information fill-in page is an order fill-in page, the third unstructured message is order completion information, the first associated platform is an e-commerce platform, and the second associated platform is a payment platform.

In an embodiment, a platform for processing an unstructured message includes: a first unstructured message receiving module, configured to receive a first unstructured message sent by a communications server, where the first unstructured message is a message received by the communications server from a first client, where the first client has account information, and the account information of the first client has bound first bound account information in the first associated platform; a first unstructured message storing module, configured to store the first unstructured message and generate a first data identifier corresponding to the first unstructured message; a first binding relationship generating module, configured to generate a binding relationship between the first bound account information and the first data identifier; a page data generating module, configured to generate data of the information fill-in page according to the first data identifier; a second unstructured message receiving module, configured to: receive a second unstructured message sent by a communications server, where the second unstructured message is the data of the information fill-in page acquired by the communications server; and after sending the data of the information fill-in page to a second client, receive, from the second client, a message generated for the data of the information fill-in page; a second unstructured message storing module, configured to store the second unstructured message and generate a second data identifier corresponding to the second unstructured message; and a second binding relationship generating module, configured to generate a binding relationship between the second bound account information and the second data identifier.

In an embodiment, the platform further includes: a page data request receiving module, configured to receive a fill-in page data request sent by the communications server, where the fill-in page data request includes the first data identifier; where the page data generating module is configured to generate the data of the information fill-in page corresponding to the first data identifier according to a preset page generating logic; and a page data returning module, configured to return the data of the information fill-in page to the communications server.

In an embodiment, a system for processing an unstructured message includes: a first client, a second client and a communications server. The first client includes: an icon identifier acquiring module, configured to acquire, in response to detecting that an icon on a client interface is clicked, an icon identifier corresponding to the icon; a first unstructured message receiving module, configured to receive a first unstructured message inputted by a first user; a first unstructured message generating module, configured to organize the icon identifier and the first unstructured message into a second unstructured message; and a first unstructured message sending module, configured to send the second unstructured message to the communications server, where the communications server is configured to send the second unstructured message to the second client and save the first unstructured message in a first associated platform having a binding relationship with the communications server, and where the first associated platform is a platform configured to store structured information, store the first unstructured message, and generate a first data identifier corresponding to the first unstructured message. The second client includes: a first message receiving module, configured to receive the second unstructured message sent by a communications server, where the second unstructured message includes the icon identifier and the first unstructured message; a message display module, configured to display the second unstructured message; a page display module, configured to display an information fill-in page when an on-click operation is detected for the second unstructured message, where the information fill-in page comprises one or more control elements; a control element value receiving module, configured to receive a control element value inputted for the control element; a second unstructured message generating module, configured to generate a third unstructured message when it is verified that the control element value is valid; and a second unstructured message sending module, configured to send the third unstructured message to the communications server, where the communications server is configured to send the third unstructured message to the first client and save the third unstructured message in the first associated platform having a binding relationship with the communications server, and where the first associated platform is a platform configured to store structured information, store the third unstructured message and generate a second data identifier corresponding to the third unstructured message. The communications server includes: a second message receiving module, configured to receive the second unstructured message sent by a first client, where the second unstructured message includes the icon identifier and the first unstructured message; a message sending module, configured to send the second unstructured message to the second client; and a message saving module, configured to save the first unstructured message in the first associated platform; a second unstructured message receiving module, configured to receive the third unstructured message sent by the second client; an unstructured message saving module, configured to save the third unstructured message in the first associated platform; and a third unstructured message sending module, configured to send the third unstructured message to the first client.

Embodiments according to the disclosure include a number of advantages. In embodiments according to the disclosure, a first unstructured message inputted by a first user into a first client may be synchronized into a first associated platform in which structured information is stored, and the first unstructured message may be stored in the first associated platform without structured edit and extraction, thereby simplifying the data processing procedure for the first associated platform.

Further, after the first unstructured message is stored in the first associated platform, data of the information fill-in page may be generated according to the first unstructured message and a predetermined page generating logic, and the data of the information fill-in page is sent to the second client by means of a communications server. After a second user inputs the control element value of the control element in the data of the information fill-in page by means of the second client, another unstructured message is generated. In this way, the second user can accomplish, in the second client, an operation that originally needs to be accomplished in the first associated platform, thereby simplifying the operation for the second user.

### BRIEF DESCRIPTION OF THE DRAWINGS

The accompanying drawings, which are incorporated in and form a part of this specification, and in which like numerals depict like elements, illustrate embodiments of the present disclosure and, together with the description, serve to explain the principles of the disclosure.

FIG. 1 is a flowchart of a method for processing an unstructured message in accordance with an embodiment of the present disclosure;

FIG. 2 is a diagram of an instant messaging session interface of a method for processing an unstructured message in accordance with an embodiment of the present disclosure;

FIG. 3 is a diagram of an instant messaging input box of a method for processing an unstructured message in accordance with an embodiment of the present disclosure;

FIG. 4 is a diagram of a binding page of a method for processing an unstructured message in accordance with an embodiment of the present disclosure;

FIG. 5 is a flowchart of a method for processing an unstructured message in accordance with an embodiment of the present disclosure;

FIG. 6 is a flowchart of a method for processing an unstructured message in accordance with an embodiment of the present disclosure;

FIG. 7 is a diagram of an instant message release box of a method for processing an unstructured message in accordance with an embodiment of the present disclosure;

FIG. 8 is a diagram of an order fill-in page of a method for processing an unstructured message in accordance with an embodiment of the present disclosure;

FIG. 9 is a diagram of an instant message release box of a method for processing an unstructured message in accordance with an embodiment of the present disclosure;

FIG. 10 is a flowchart of a method for processing an unstructured message in accordance with an embodiment of the present disclosure;

FIG. 11 is a flowchart of a method for processing an unstructured message in accordance with an embodiment of the present disclosure;

FIG. 12 is a flowchart of a method for processing an unstructured message in accordance with an embodiment of the present disclosure;

FIG. 13 is a block diagram of a client for processing an unstructured message in accordance with an embodiment of the present disclosure;

FIG. 14 is a block diagram of a server for processing an unstructured message in accordance with an embodiment of the present disclosure;

FIG. 15 is a block diagram of a client for processing an unstructured message in accordance with an embodiment of the present disclosure;

FIG. 16 is a block diagram of a server for processing an unstructured message in accordance with an embodiment of the present disclosure;

FIG. 17 is a block diagram of a platform for processing an unstructured message in accordance with an embodiment of the present disclosure; and

FIG. 18 is a block diagram of a system for processing an unstructured message in accordance with an embodiment of the present disclosure.

FIG. 19 is a block diagram of an example of a computing device capable of implementing embodiments according to the present disclosure.

### DETAILED DESCRIPTION

Reference will now be made in detail to the various embodiments of the present disclosure, examples of which are illustrated in the accompanying drawings. While described in conjunction with these embodiments, it will be understood that they are not intended to limit the disclosure to these embodiments. On the contrary, the disclosure is intended to cover alternatives, modifications and equivalents, which may be included within the spirit and scope of the disclosure as defined by the appended claims. Furthermore, in the following detailed description of the present disclosure, numerous specific details are set forth in order to provide a thorough understanding of the present disclosure. However, it will be understood that the present disclosure may be practiced without these specific details. In other instances, well-known methods, procedures, components, and circuits have not been described in detail so as not to unnecessarily obscure aspects of the present disclosure.

Some portions of the detailed descriptions that follow are presented in terms of procedures, logic blocks, processing, and other symbolic representations of operations on data bits within a computer memory. These descriptions and representations are the means used by those skilled in the data processing arts to most effectively convey the substance of their work to others skilled in the art. In the present application, a procedure, logic block, process, or the like, is conceived to be a self-consistent sequence of steps or instructions leading to a desired result. The steps are those utilizing physical manipulations of physical quantities. Usually, although not necessarily, these quantities take the form of electrical or magnetic signals capable of being stored, transferred, combined, compared, and otherwise manipulated in a computer system. It has proven convenient at times, principally for reasons of common usage, to refer to these signals as transactions, bits, values, elements, symbols, characters, samples, pixels, or the like.

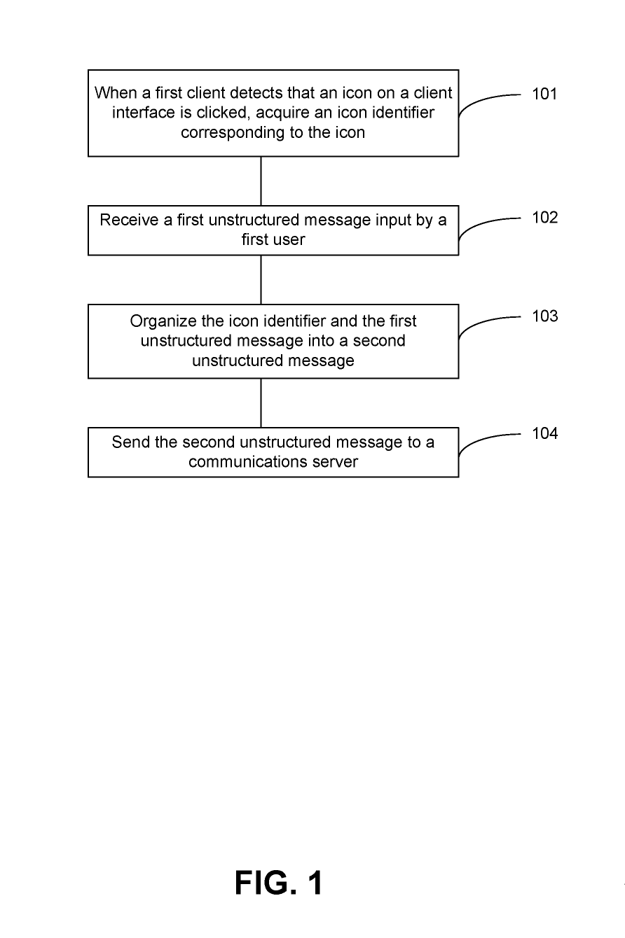

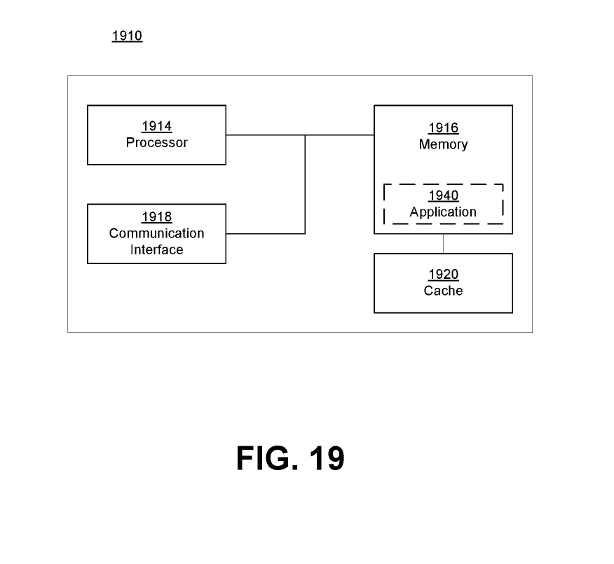

It should be borne in mind, however, that all of these and similar terms are to be associated with the appropriate physical quantities and are merely convenient labels applied to these quantities. Unless specifically stated otherwise as apparent from the following discussions, it is appreciated that throughout the present disclosure, discussions utilizing terms such as “acquiring,” “receiving,” “organizing,” “sending,” “generating,” “rendering,” “submitting,” “saving,” “looking up,” “adding,” “displaying,” “triggering,” “returning,” “jumping,” or the like, refer to actions and processes (e.g., the flowcharts of FIGS. 1, 5, 6, 10, 11 and 12) of a computer system or similar electronic computing device or processor (the computing device 1910 of FIG. 19). A computer system or similar electronic computing device manipulates and transforms data represented as physical (electronic) quantities within the computer system memories, registers or other such information storage, transmission or display devices.

Embodiments described herein may be discussed in the general context of computer-executable instructions residing on some form of computer-readable storage medium, such as program modules, executed by one or more computers or other devices. By way of example, and not limitation, computer-readable storage media may comprise non-transitory computer storage media and communication media. Generally, program modules include routines, programs, objects, components, data structures, etc., that perform particular tasks or implement particular abstract data types. The functionality of the program modules may be combined or distributed as desired in various embodiments.

Computer storage media includes volatile and nonvolatile, removable and non-removable media implemented in any method or technology for storage of information such as computer-readable instructions, data structures, program modules or other data. Computer storage media includes, but is not limited to, random access memory (RAM), read only memory (ROM), electrically erasable programmable ROM (EEPROM), flash memory or other memory technology, compact disk ROM (CD-ROM), digital versatile disks (DVDs) or other optical storage, magnetic cassettes, magnetic tape, magnetic disk storage or other magnetic storage devices, or any other medium that can be used to store the desired information and that can accessed to retrieve that information.

Communication media can embody computer-executable instructions, data structures, and program modules, and includes any information delivery media. By way of example, and not limitation, communication media includes wired media such as a wired network or direct-wired connection, and wireless media such as acoustic, radio frequency (RF), infrared and other wireless media. Combinations of any of the above can also be included within the scope of computer-readable media.

FIG. 1 illustrates a flowchart of a method for processing an unstructured message according to an embodiment of the present disclosure. In Step 101, when a first client detects that an icon on a client interface is clicked, an icon identifier corresponding to the icon is acquired. The client refers to a program that corresponds to the server and provides local service for a user. For example, the client may include an instant messaging client, a web browser client, etc.

In embodiments of the present disclosure, the first client may be a client which a message sender (e.g., a first user) logs onto. In an embodiment, the process of the first user logging onto the first client may be as follows. The first user inputs a username and a password into a login interface of the first client to request to log onto the first client. The first client sends the username and the password to a communications server. After receiving the username and the password, the communications server authenticates the identity of the first user by reading a user database, and registers the IP address of the first user, the client version number, and the TCP/UDP port number in use or the like if both the username and the password are correct. A symbol indicating a successful logon by the first user is then returned, and the first user is then online. Further, if the first client is an instant messaging client, the communications server may also send relevant information about the first client to a terminal of a simultaneously online instant messaging “buddy” according to a buddy list stored by the first client on the communications server. The information includes an online status, an IP address, a TCP port number used by the first client, etc. Meanwhile, the communications server sends the buddy list and the relevant information stored by the first client on the communications server back to the first client. The information includes an online status, an IP address, a TCP port number used by the first client, etc. After receiving the buddy list and the relevant information, the first client displays the buddy list and the online status.

The client interface of the first client may be a session interface having a message input box in the first client. The client interface may be, for example, a chat interface of an instant messaging client, a message publishing interface of a browser client such as a forum or a personal homepage, etc. In an embodiment, after the first user successfully logs onto the first client, the first user may directly enter into a session interface. For example, after the first user logs onto a personal homepage, the first user directly enters into the session interface of the personal homepage or, after the first user successfully logs onto the first client, the first user selects a buddy from the buddy list with whom to conduct a conversation and enters into the session interface with the buddy. Alternatively, after the first user successfully logs onto the first client, the first user selects a group with whom to conduct a conversation and enters into the session interface with the group.

The session interface of the first client has a designated icon, which may be an icon formed after a plug-in is installed on the first client. The plug-in (also referred to as an addin, add-in, addon, or add-on) is a program written for an application program interface in conformity with a norm or standard. The objective of a plug-in is to develop a program so as to implement a function that is beyond the scope of the original pure system platform/application software, which may only run under a system platform (may simultaneously support multiple platforms) stipulated by the program and cannot run separately outside of a designated platform. Much software has plug-ins and many types of plug-ins exist. For example, after a related plug-in is installed in a browser, the browser can directly invoke the plug-in to process a specific type of file.

In an implementation, the plug-in installed in a client may be a window plug-in, which may be embedded into the client in the following manner. A program corresponding to the client creates an open window including an open access area after receiving a notice indicating that creation of the open window has been completed. The notice is sent by a plug-in manager (the plug-in manager may be configured to detect the service condition of the client and inform the client when it detects that the creation of the open window is completed), and a loader process independent of the program corresponding to the client is created. The loader process creates an agent window as a child window of the open window. A background service processing code corresponding to the agent window is an agent module which loads the plug-in, and the plug-in creates a plug-in window which is a child window of the agent window; both the plug-in window and the agent window are in the same process. Accordingly, the plug-in completes an access process. The plug-in may also be embedded into the client in other ways.

In an embodiment of the present disclosure, Step 101 may include substeps (not shown).

In a first substep, a plug-in corresponding to the icon is triggered when it is detected that the first user has clicked on the icon on the client interface. The plug-in in the client interface is triggered when it is clicked; specifically, after the plug-in is embedded into the first client, an icon identifying the plug-in is displayed in a particular area of the first client. The particular area may be an upper area, a lower area, a left area, or a right area of an input box of the first client or a display window. After the icon is clicked, the plug-in starts running.

In a second substep, an icon identifier corresponding to the plug-in is obtained. The icon identifier is an identifier configured to describe a functional feature of a plug-in. For example, an icon identifier of a “request a song” icon in a group interface of an instant messaging client is “request a song.”

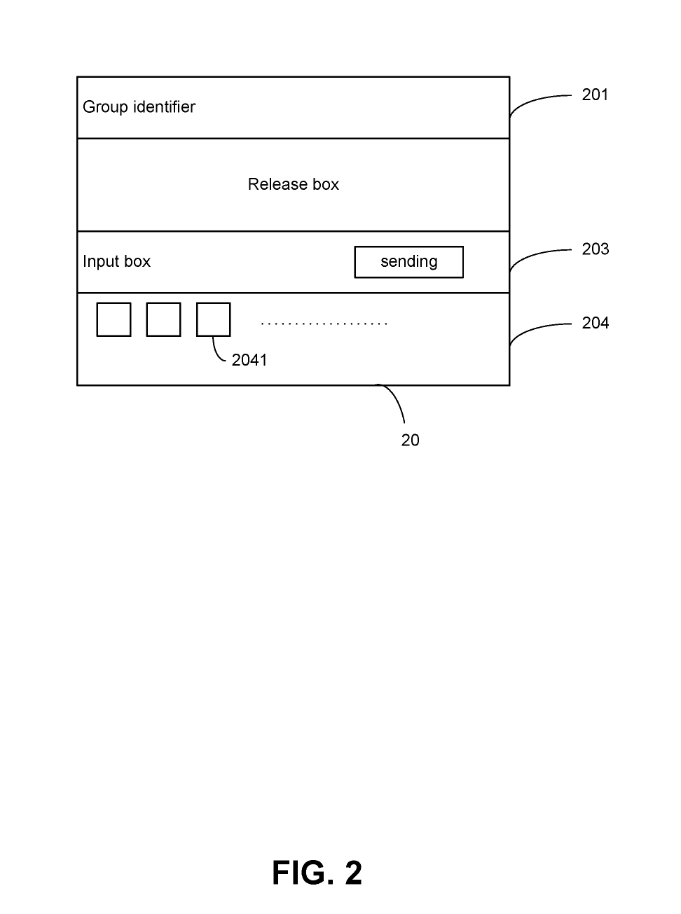

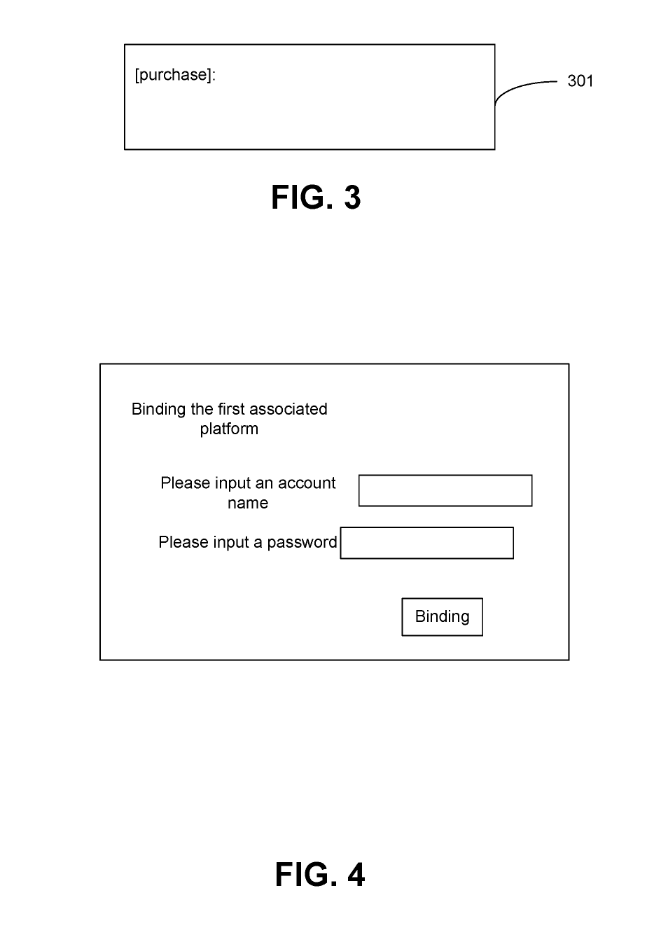

An association relationship among a plug-in, a corresponding icon, and a corresponding icon identifier is saved in the first client. When it is detected that the icon of the first client is clicked, the icon currently clicked or the icon identifier of the plug-in triggered may be acquired by means of the association relationship. After the icon identifier is acquired, the icon identifier may also be displayed in an input box of the first client. As an example, if embodiments of the disclosure are applied to the field of e-commerce, the first user may be a seller user, the first client may be a seller client, and the icon identifier may be a purchase identifier. For example, in the schematic diagram of the instant messaging session interface as shown in FIG. 2, the instant messaging session interface 20 is a group session interface. A group identifier 201 may include the name and the head portrait of the group, and a toolbar box 204 includes the icon of the multifunctional plug-in provided by the seller client. The icon clicked may be a “purchase” icon 2041. When a user clicks on the “purchase” icon 2041, a “purchase” plug-in is triggered, the icon identifier “purchase” corresponding to the icon may be acquired, and the icon identifier is displayed in an input box 203, for example, the instant messaging input box as shown in FIG. 3.

In Step 102, a first unstructured message input by a first user is received. In embodiments of the present disclosure, after the first user enters into the client interface of the first client and clicks on the icon of the client interface, the first unstructured message may be input in the input box. The first unstructured message may be positioned after the icon identifier, where the first unstructured message is unstructured information. Unlike the structured information, unstructured information refers to data not organized by a specific format and whose key-value is difficult to determine. In the above example, the first unstructured message may be commodity information, and commodity information input by a seller into the input box may be positioned after the “purchase” identifier.

In Step 103, the icon identifier and the first unstructured message are organized into a second unstructured message. After the first client receives the first unstructured message input by the first user, the first unstructured message may be combined with the icon identifier of the clicked icon to generate the second unstructured message, where the second unstructured message is also unstructured information.

In Step 104, the second unstructured message is sent to a communications server, where the communications server is configured to send the second unstructured message to a second client and save the first unstructured message in a first associated platform, which has a binding relationship with the communications server. After the first client generates the second unstructured message, the second unstructured message may be sent to the communications server. The communications server may send the second unstructured message to the second client and save the first unstructured message in the first associated platform, which has a binding relationship with the communications server. The processing procedure after the communications server receives the second unstructured message will be described in detail below.

In embodiments of the present disclosure, the first associated platform has a preset binding relationship with the communications server. In practice, the binding relationship is achieved by the first user by clicking the account binding function of the first client to bind the account information, by which the first user logs onto the first client, and the account information (the first bound account information), by which the first user logs onto the first associated platform. The procedure of the binding operation may be expressed as follows: the first client generates a binding request; sends the binding request to the communications server; receives binding page data corresponding to the binding request returned by the communications server; renders the binding page data to output a corresponding binding page; receives first bound account information input by the first user in the binding page; and submits the first bound account information to the communications server, where the communications server is configured to generate a binding relationship between account information of the first client and the first bound account information. Specifically, in an embodiment, when the first user clicks on the account binding function of the first client, the first client generates a binding request and sends it to the communications server in which binding page data is saved. After receiving the binding request, the communications server returns the binding page data corresponding to the binding request and the client locally renders the binding page data to display a binding page as shown in FIG. 4. The binding page includes an information input box provided for inputting first bound account information. After the first user inputs the first bound account information in the information input box, the first client sends the first bound account information to the communications server. After the communications server verifies that the first bound account information is valid, the communications server generates a binding relationship between account information of the first client and the first bound account information and stores the binding relationship. If the first user does not register login account information in the first associated platform, the first user may input account information for logging onto the first client into the information input box as shown in FIG. 4. In this way, the first user may use the account information of the first client to log onto the first associated platform.

In an embodiment of the present disclosure, the first client is a client for receiving unstructured information. The first associated platform may be a platform for storing structured information. For example, if the first client is an instant messaging client, the first associated platform may be an e-commerce platform in which structured commodity information is stored.

In embodiments of the disclosure, the first unstructured message input by the first user into the first client may be synchronized into the first associated platform in which structured information is stored, and the first unstructured message may be stored in the first associated platform without structured edit and extraction, thereby simplifying the data processing procedure for the first associated platform.

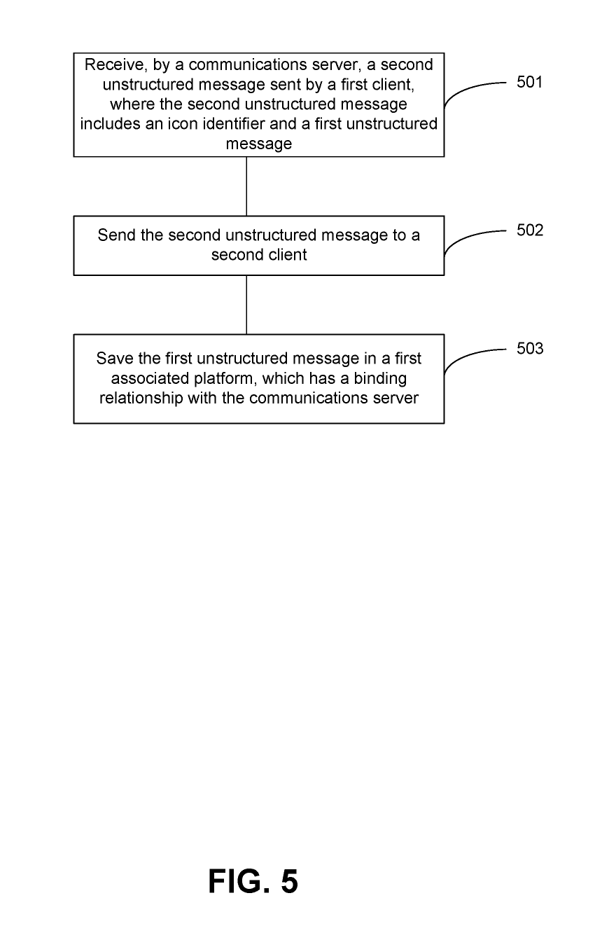

FIG. 5 illustrates a flowchart of a method for processing an unstructured message according to an embodiment of the present disclosure.

In Step 501, a second unstructured message sent by a first client, where the second unstructured message includes an icon identifier and a first unstructured message, is received by a communications server. After receiving the second unstructured message, the communications server may parse the second unstructured message, add an on-click event for the second unstructured message when an icon identifier is recognized, and send parameter information corresponding to the on-click event to the second client. The second client is a client for receiving a message sent by the first client; for example, the second client is a buyer client if the first client is a seller client. When the second client triggers the on-click event, response parameter information corresponding to the parameter information is returned to the communications server. After receiving the response parameter information, the communications server may start acquiring the subsequent data. The on-click event is information or notification that is sent out in case of, for example, occurrence of a motion or a change of a state. Generally, a change of a state arises by initialization of a user interface, for example, a button on-click or other program logic.

In Step 502, the second unstructured message is sent to a second client. After adding an on-click event for the second unstructured message, the communications server sends parameter information of the on-click event to the second client and also (e.g., simultaneously) sends the second unstructured message to the second client via a message distributing mechanism. In an implementation manner, Step 502 may include substeps (not shown).

In a first substep, address information of the second user corresponding to the user identifier of the second user is looked up in a local database by the communications server.

Specifically, the second unstructured message sent by the first client to the communications server may carry the user identifier of the second user logging onto the second client, for example, the name of a certain buddy or the name of a certain group in the instant messaging client.

Buddy list information, or group information, corresponding to the first user logging onto the first client is saved in the communications server. It is saved in the buddy list information association relationship between user identifiers of one or more buddies and their address information. It is also saved in both the group information as a group identifier as well as the association relationship between user identifiers of one or more members in the group and their address information. After receiving the user identifier of the second user sent by the first client, the communications server matches the user identifier of the second user and, if the user identifier of the second user is an identifier of a certain buddy, acquires address information of the buddy; alternatively, if the user identifier of the second user is an identifier of a certain group, the communications server acquires address information of all members in the group.

In the second substep of Step 502, the second unstructured message is sent to the second client corresponding to the address information of the second user. After acquiring the address information of the buddy or the address information of all members in the group, the communications server sends the second unstructured message to the second client corresponding to the address information.

In Step 503, the first unstructured message in a first associated platform, which has a binding relationship with the communications server, is saved. While sending the second unstructured message, the communications server may also synchronize the first unstructured message included in the second unstructured message to the first associated platform, which has a binding relationship with the communications server. In an implementation, the binding relationship between the communications server and the first associated platform may be generated in the following way: the communications server receives a binding request sent by the first client; acquires binding page data corresponding to the binding request and returns it to the first client; receives first bound account information submitted by the first client for the binding page data, where the first bound account information is account information registered by a first user on the first associated platform for logging onto the first client; and generates a binding relationship between the account information of the first client and the first bound account information. Specifically, when the first user clicks on the account binding function of the first client, the first client generates a binding request and sends it to the communications server, in which binding page data is saved. After receiving the binding request, the communications server returns the binding page data corresponding to the binding request, and the client locally renders the binding page data to display a binding page, where the binding page includes an information input box provided for the first user to input first bound account information. After the first user inputs the first bound account information into the information input box, the first client sends the first bound account information to the communications server. After verifying that the first bound account information is valid, the communications server generates a binding relationship between account information of the first client and the first bound account information and stores the binding relationship.

In an embodiment of the present disclosure, Step 503 may include substeps (now shown). In a first substep, a first synchronous message is generated, where the first synchronous message includes the first unstructured message and the first bound account information. In a second sub step, the first synchronous message is sent to the first associated platform, where the first associated platform is configured to store the first unstructured message. A first data identifier corresponding to the first unstructured message and a binding relationship between the first bound account information and the first data identifier are then generated.

After acquiring the first unstructured message by parsing the second unstructured message, the communications server may synchronize the first unstructured message to the first associated platform. Specifically, the communications server may generate a first synchronous message, which includes the first unstructured message and the first bound account information. Then, the communications server invokes an API (Application Program Interface) of the first associated platform to send the first synchronous message to the first associated platform. After receiving the first synchronous message, the first associated platform stores the first unstructured message, generates a first data identifier for the first unstructured message, and generates a binding relationship between the first bound account information and the first data identifier. For example, if the first unstructured message is commodity information, then the first client is a seller client and the first associated platform is an e-commerce platform. After the seller client sends the first synchronous message to the e-commerce platform, the e-commerce platform saves the commodity information, generates a commodity number (identifier) for the commodity information, and generates an association relationship between the commodity number and an account number of the seller for logging onto the e-commerce platform. Specifically, in an embodiment, one record regarding commodity information of the seller is created in a background commodity database of the e-commerce platform to facilitate the e-commerce platform to manage of all published commodity information. An order fill-in page of the commodity information may be generated in the e-commerce platform by using the original order fill-in page generating logic. After generating a first data identifier, the first associated platform may also return the first data identifier to the communications server and store the association relationship between the first data identifier and the second unstructured message on the communications server side.

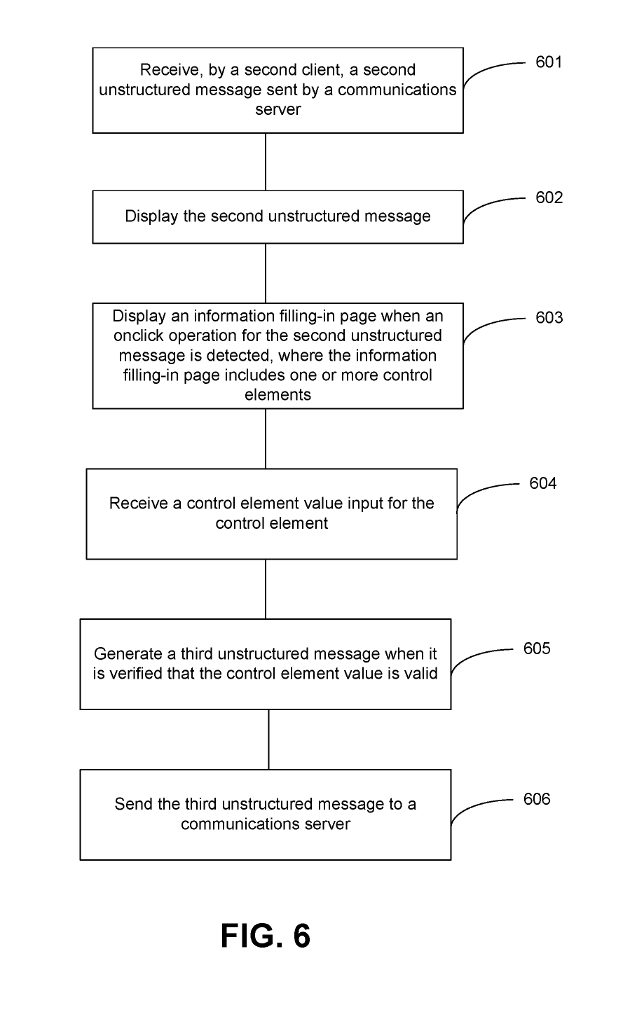

FIG. 6 illustrates a step flowchart of a method for processing an unstructured message according to an embodiment of the application.

In Step 601, a second client receives a second unstructured message sent by a communications server, where the second unstructured message includes an icon identifier and a first unstructured message. In an implementation, while receiving the second unstructured message sent by the communications server, the second client may also receive parameter information of an on-click event sent by the communications server. The parameter information of the on-click event may be parameter information relating to the on-click event sent by the communications server to the second client after the on-click event is added for the second unstructured message on the communications server side.

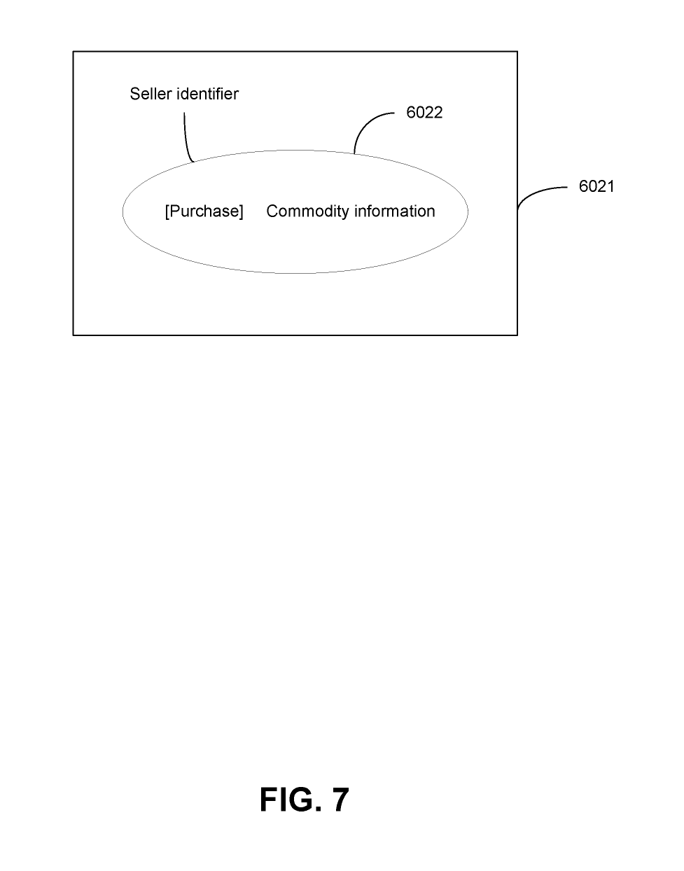

In Step 602, the second unstructured message is displayed. After receiving the second unstructured message sent by the communications server, the second client locally renders a display of the second unstructured message. The second unstructured message received by the second client may carry the user identifier of the first user. When the second unstructured message is displayed, the user identifier of the first user may also be displayed. In the diagram of an instant message publishing box as shown in FIG. 7, the publishing box 6021 includes a seller identifier and commodity information 6022 carrying a purchase identifier.

In Step 603, an information fill-in page is displayed when an on-click operation for the second unstructured message is detected, where the information fill-in page includes one or more control elements. The on-click event is triggered when an on-click operation for the second unstructured message is detected as the on-click event is added for the second unstructured message.

In an implementation of embodiments of the present disclosure, Step 603 may include substeps (not shown). In a first substep, the on-click event is triggered when an on-click operation for the second unstructured message is detected. In a second substep, response parameter information corresponding to the on-click event is generated and returned to the communications server. In a third substep, data of the information fill-in page sent by the communications server is received, where the data of the information fill-in page includes one or more control elements. In a fourth substep, the data of the information fill-in page is rendered in a display of the corresponding information fill-in page.

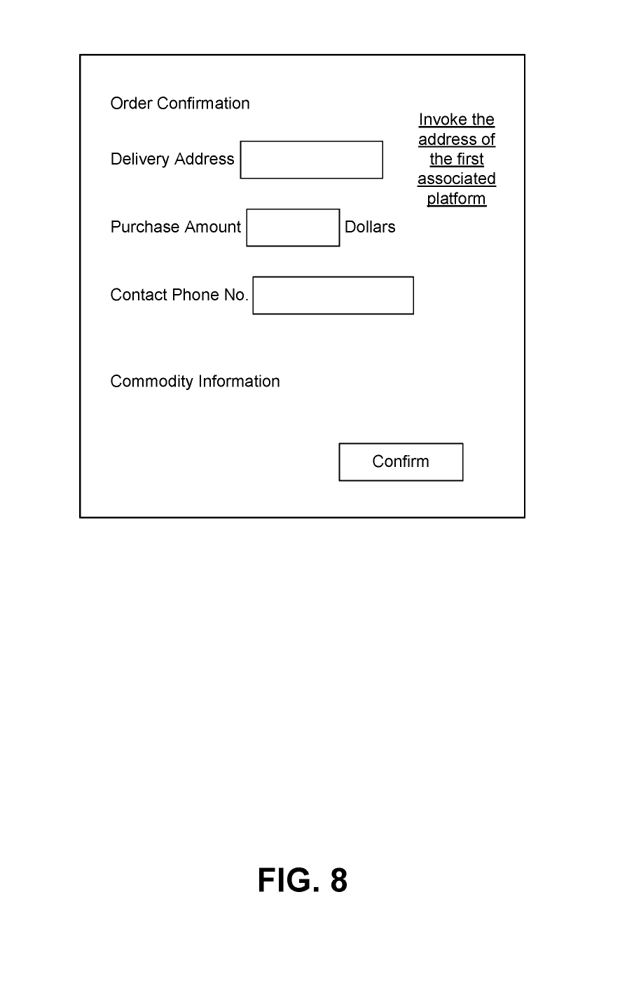

Specifically, in an embodiment, after the on-click event is triggered in the second client, the second client generates response parameter information according to parameter information corresponding to the on-click event and sends it to the communications server. After receiving the response parameter information, the communications server acquires data of the information fill-in page according to programming logic and sends it to the second client. The second client renders the data of the information fill-in page to display an information fill-in page in the second client. The information fill-in page is a page associated with the first unstructured message, which may include the first unstructured message. For example, if the first unstructured message is commodity information, the information fill-in page may be an order fill-in page, as shown in the schematic diagram of the order fill-in page in FIG. 8 (e.g., the buyer may place an order by clicking commodity information displayed in an instant messaging client or a browser client in the form of unstructured information). For the seller, it is enough to publish commodity information in an unstructured form in the instant messaging client or the browser client, thereby eliminating the necessity to fill in a structured category in the e-commerce platform to publish commodity information. For the buyer, an order may be placed by clicking commodity information displayed in the instant messaging client or the browser client in the form of unstructured information, thereby simplifying the operation for placing an order.

In practice, the data of the information fill-in page may include one or more control elements, where the control element may be an element having an attribute of an input box provided for a user to input information, such as an address fill-in box, a contact phone fill-in box, etc. As shown in FIG. 8, if the information fill-in page is an order fill-in page, the control element may be an order amount fill-in box, a contact address fill-in box, or a contact phone fill-in box required for creating an order. In embodiments of the present disclosure, the information fill-in page may be displayed in the local second client without jumping to other clients, thereby reducing the number of interactions between the second client and other clients, saving bandwidth resources, and improving the data processing capacity.

In Step 604, a control element value input for the control element is received. After an information fill-in page is displayed, the second user may fill in corresponding information in the information fill-in page displayed in the second client. Specifically, the second user inputs a control element value according to a control element. For example, a page control element value input in the contact address fill-in box is a contact address, a page control element value input in the contact phone fill-in box is a contact phone, and a page control element value input in the order amount fill-in box is an order amount. In an implementation, the second user also has second bound account information bound with the account information of the second client. In addition to filling in a corresponding control element value in an information fill-in page, the second user may also invoke the second bound account information in the first associated platform as a control element value. Specifically, the information fill-in page has a control for invoking information; when the second user clicks on the control, the second client generates an information invoking request, which includes a corresponding control element identifier, and sends it to the communications server. After receiving the information invoking request, the communications server acquires the control element value corresponding to the information invoking request and returns it to the client (the detailed process of acquiring the control element value by the communications server will be described below). For example, as shown in FIG. 8, the second user may directly edit a delivery address in a delivery address input box on the order fill-in page or click on function buttons such as “invoke the address of the first associated platform” to send out an information invoking request so as to acquire address information from a bound account corresponding to the first associated platform.

Regarding the binding relationship between the account information of the second client and the second bound account information, reference may be made to the process of generating the binding relationship between the account information of the first client and the first bound account information of the embodiments shown in FIG. 1 and FIG. 5.

In Step 605, upon verification that the control element value is valid, a third unstructured message is generated. The data of the information fill-in page returned by the communications server to the second client may further include data format information of a control element. After all required control element values are filled in, the second client may verify whether an input of a control element value is valid according to the data format information (e.g., whether or not a contact address is in conformity with an address fill-in format, if a contact phone is a mobile phone number, whether or not the number is composed of 11 digits, whether or not an amount is filled in with Arabic numerals, etc.).

In an implementation manner of the embodiments of the present disclosure, Step 605 may include substeps (not shown). In a first substep, a jump request of the second associated platform according to the control element value is generated when it is verified that the control element value is valid. In the event that all control element values are valid after verification, the second client may also generate a jump request of the second associated platform according to one or more control element values so as to request a jump to the second associated platform. The second associated platform is a platform having a cooperative relationship with the communications server or the first associated platform, which is used for processing a certain control element value according to a specified rule. For example, if the first associated platform is an e-commerce platform, the second associated platform may be a payment platform, which is mainly used for payment processing of an order amount.

In a second substep of Step 605, the jump request is sent to a communications server, where the communications server is configured to jump to the second associated platform according to the jump request and receive response information returned by the second associated platform; the second associated platform is configured to process the control element value and return the response information.

After generating the jump request, the second client sends the jump request to the communications server. After receiving the jump request, the communications server jumps to the second associated platform so that the second client processes the control element value and returns response information to the communications server. The communications server then sends the response information to the second client. For example, after performing payment processing on an order amount, the payment platform returns response information subject to payment processing to the communications server, which further sends the response information to the second client.

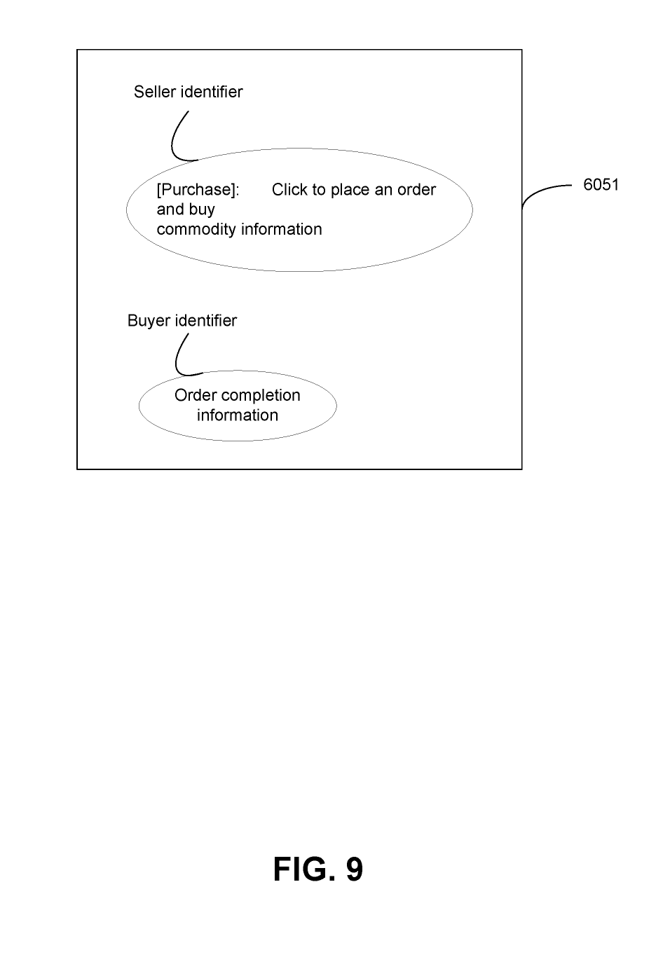

In a third substep of Step 605, the response information sent by the communications server according to the jump request is received and, if it is determined that the response information is successful response information, a third unstructured message is generated in a fourth substep. The second client judges whether the response information is successful (satisfactory) response information. If the response information is successful response information, the second client generates a third unstructured message, which also is unstructured information. For example, if response information returned by the payment platform is pay success information, the communications server sends the pay success information to the second client. After receiving the pay success information, the second client generates a third unstructured message. In this example, the third unstructured message may be order completion information. For example, in the schematic diagram of an instant message release box as shown in FIG. 9, the buyer client generates order completion information in the release box 6051 as shown in FIG. 9 to indicate when and how much the buyer user bought commodities. Correspondingly, if one or more control element values are invalid, the second client generates a prompt message including a reason for invalidation and displays the prompt message to the second user.

In Step 606, the third unstructured message is sent to a communications server, where the communications server is configured to send the third unstructured message to a first client and save the third unstructured message in a first associated platform, which has a binding relationship with the communications server. After generating a third unstructured message, the second client sends the third unstructured message to the communications server, and the communications server sends the third unstructured message to the first client and saves the third unstructured message in the first associated platform having a binding relationship with the communications server.

In embodiments of the present disclosure, after the first unstructured message is stored in the first associated platform, data of the information fill-in page may be generated according to the first unstructured message and a predetermined page generating logic. The data of the information fill-in page is sent to the second client by means of the communications server. After the second user inputs the control element value of the control element in the data of the information fill-in page by means of the second client, the third unstructured message is generated. In this way, the second user can accomplish, in the second client, an operation that originally needs to be accomplished in the first associated platform, thereby simplifying the operation of the second user.

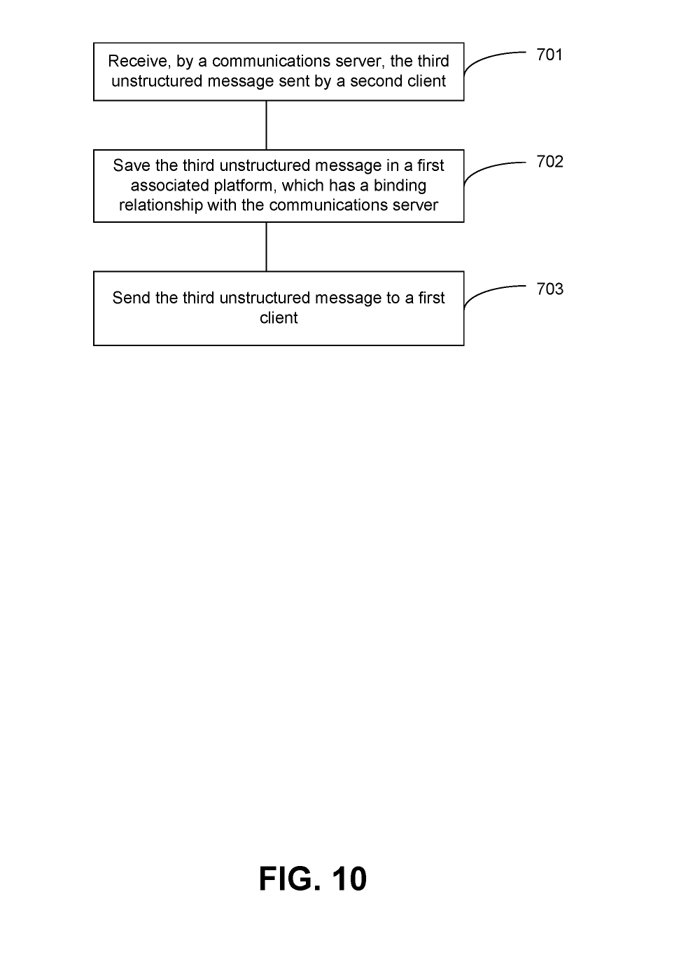

FIG. 10 illustrates a flowchart of a method for processing an unstructured message according to an embodiment of the present disclosure.

In Step 701, the third unstructured message sent by a second client is received by a communications server. The third unstructured message is configured to: display the second unstructured message after the second client receives the second unstructured message; display an information fill-in page after an on-click operation for the second unstructured message is detected; display the information fill-in page, which includes one or more control elements; receive a control element value input for the control element; and generate, when it is verified that the control element value is valid, the second unstructured message that includes a first unstructured message and an icon identifier. Specifically, in an embodiment, after receiving the second unstructured message sent by the first client, the communications server adds an on-click event for the second unstructured message and sends the second unstructured message, for which the on-click event is added, to the second client. The second unstructured message has a user identifier of the second user for logging onto the second client. The communications server acquires address information of the second user according to the user identifier of the second user and sends the second unstructured message to the second client according to the address information of the second user. After receiving the second unstructured message, the second client displays the second unstructured message. After detecting that the on-click event is triggered, the second client returns response parameter information to the communications server. The communications server acquires corresponding data of the information fill-in page according to the response parameter information and sends it to the second client, where the data of the information fill-in page includes one or more control elements.

In an implementation, the manner of acquiring the corresponding data of the information fill-in page by the communications server according to the response parameter information may include substeps (not shown). In a first substep, the communications server acquires a first data identifier corresponding to the first unstructured message. Specifically, when the communications server adds an on-click event for the second unstructured message, the communications server associates the on-click event with the first data identifier returned by the first associated platform and acquires the corresponding first data identifier according to the association relationship when the on-click event is triggered. In a second substep, a fill-in page data request according to the first data identifier is generated. The communications server generates the page data request according to the first data identifier, and the page data request is configured to request the first associated platform to acquire corresponding processed data.

In a third substep, the fill-in page data request is sent to a first associated platform, where the first associated platform is configured to generate data of the information fill-in page corresponding to the first data identifier according to preset page generating logic, and the data of the information fill-in page is returned to the communications server. The communications server sends the page data request to the first associated platform. After receiving the page data request, the first associated platform locates a concrete data record according to the first data identifier, then generates the data of the information fill-in page corresponding to the data record according to preset page generating logic of the first associated platform, and returns the data to the communications server. For example, when the first associated platform is an e-commerce platform and the first data identifier is a commodity number, after receiving a page data request sent by the communications server, the e-commerce platform locates a corresponding commodity record according to the commodity number, generates an order fill-in page according to the commodity record, and sends data of the order fill-in page to the communications server.

In a fourth substep, the data of the information fill-in page is received and returned by the first associated platform corresponding to the fill-in page data request. Then, in a fifth substep, the data of the information fill-in page is returned to the second client. After receiving the data of the information fill-in page returned by the first associated platform, the communications server transfers the data of the information fill-in page to the second client, and the second client displays the corresponding information fill-in page. The information fill-in page includes one or more control elements, and the second user may directly input a control element value corresponding to the control element, or the second user may also invoke, by means of the second client, the second bound account information in the first associated platform as the control element value.

In an implementation, the manner of invoking, by the second client, the second bound account information in the first associated platform as the control element value may be as follows. The information fill-in page has a control for invoking information. When the second user clicks on the control, the second client generates an information invoking request and sends it to the communications server. The communications server acquires account information of the second client, further acquires the corresponding second bound account information according to the account information, and then sends both the information invoking request and the second bound account information to the first associated platform. The first associated platform locates a corresponding data record according to the second bound account information, seeks (from the data record) the control element value corresponding to the control element identifier, and sends it to the communications server. Then, the communications server returns the control element value corresponding to the control element identifier to the second client.

After all the control elements are filled in, the second client verifies whether corresponding control element values are valid. If all the control element values are valid, then the second client generates a jump request of the second associated platform and sends it to the communications server. After receiving the jump request, the communications server jumps to the second associated platform, which is configured to process the control element value and return response information. After receiving the response information, the communications server sends the response information to the second client. After judging that the response information is successful response information, the second client generates a third unstructured message and sends it to the communications server.

In Step 702, the third unstructured message in a first associated platform having a binding relationship with the communications server is saved. After receiving the third unstructured message, the communications server synchronizes the third unstructured message to the first associated platform. In an implementation, Step 702 may include substeps (not shown).

In a first sub step, a second synchronous message, where the second synchronous message includes the third unstructured message and the second bound account information, is generated. In a second substep, the second synchronous message is sent to the first associated platform, where the first associated platform is configured to store the third unstructured message. A second data identifier corresponding to the third unstructured message as well as a binding relationship between the second bound account information and the second data identifier are generated.

After receiving the third unstructured message, the communications server may synchronize the third unstructured message to the first associated platform. Specifically, the communications server may generate a second synchronous message, which includes the third unstructured message and the second bound account information. Then, the communications server invokes an API of the first associated platform to send the second synchronous message to the first associated platform. After receiving the second synchronous message, the first associated platform stores the third unstructured message, generates a second data identifier for the third unstructured message, and generates a binding relationship between the second bound account information and the second data identifier. For example, if the third unstructured message is order completion information, the second client is an instant messaging client and the first associated platform is an e-commerce platform. After the instant messaging client sends the second synchronous message to the e-commerce platform, the e-commerce platform saves the order completion information, generates an order number of the order completion information, and generates an association relationship between the order number and a second bound account (e.g., a record regarding order information of the buyer is created in the order database of the e-commerce platform). After generating a second data identifier, the first associated platform may also return the second data identifier to the communications server and store the association relationship between the second data identifier and the third unstructured message in the communications server side.

In Step 703, the third unstructured message is sent to a first client. The third unstructured message carries a user identifier of the first user. The communications server acquires address information of the first user according to the user identifier of the first user and sends the third unstructured message to the first client according to the address information of the first user.

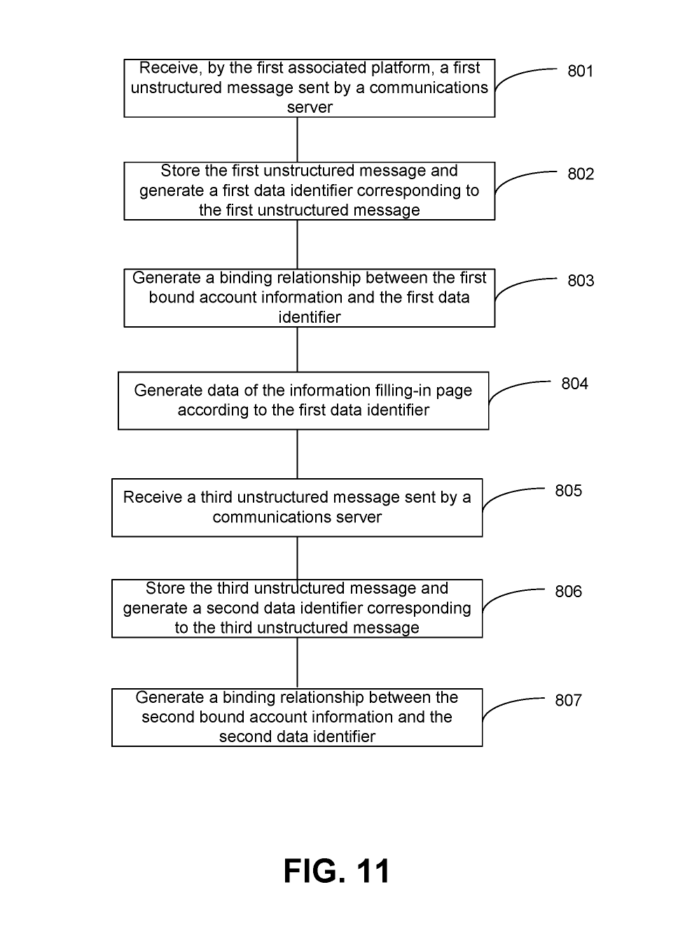

FIG. 11 illustrates a flowchart of a method for processing an unstructured message according to an embodiment of the present disclosure.

In Step 801, a first unstructured message sent by a communications server is received by the first associated platform, where the first unstructured message is a message received by the communications server from a first client, the first client has account information, and the account information of the first client has first bound account information in the first associated platform. Specifically, a preset binding relationship exists between a server of the first associated platform and the communications server. After receiving the first unstructured message from the first client, the communications server sends the message to the first associated platform in order to synchronize the first unstructured message in the first associated platform.

In Step 802, the first unstructured message is stored and a first data identifier corresponding to the first unstructured message is generated.

In Step 803, a binding relationship between the first bound account information and the first data identifier is generated. After receiving the first unstructured message sent by the communications server, the first associated platform creates a data record of the first unstructured message in a local database. In an embodiment, the data record may include the first unstructured message, the first data identifier generated for the first unstructured message, and the first bound account information registered by the first user in the first associated platform.

In Step 804, data of the information fill-in page is generated according to the first data identifier. After generating the first data identifier, the first associated platform may send the first data identifier to the communications server and store the association relationship between the first data identifier and the first unstructured message in the communications server. After receiving a fill-in page data request generated by the communications server according to the first data identifier, the first associated platform generates the corresponding data of the information fill-in page in accordance with the first data identifier according to a preset page generating logic, and returns the data of the information fill-in page to the communications server. The communications server further sends the data of the information fill-in page to the second client, and the second client displays a corresponding information fill-in page which includes one or more control elements. The second user may fill in control element values corresponding to the one or more control elements, and the second client verifies whether the corresponding control element values are valid. If all the control element values are valid, the second client generates a jump request of the second associated platform and sends it to the communications server. After receiving the jump request, the communications server jumps to the second associated platform, which is configured to process the control element value and return response information. After receiving the response information, the communications server sends the response information to the second client. After judging that the response information is successful response information, the second client generates a third unstructured message and sends it to the communications server.

In Step 805, a third unstructured message sent by a communications server is received, where the third unstructured message is the data of the information fill-in page acquired by the communications server. After the data of the information fill-in page is sent to a second client, a message generated for the data of the information fill-in page is received from the second client.

In Step 806, the third unstructured message is stored and a second data identifier corresponding to the third unstructured message is generated.

In Step 807, a binding relationship between the second bound account information and the second data identifier is generated.

The communications server further sends the third unstructured message to the first associated platform, to synchronize the third unstructured message in the first associated platform. Specifically, after receiving the third unstructured message, the first associated platform creates, in the local database, a data record of the third unstructured message. In an embodiment, the data record may include the third unstructured message, the second data identifier generated for the third unstructured message, and the second bound account information registered by the second user in the first associated platform.

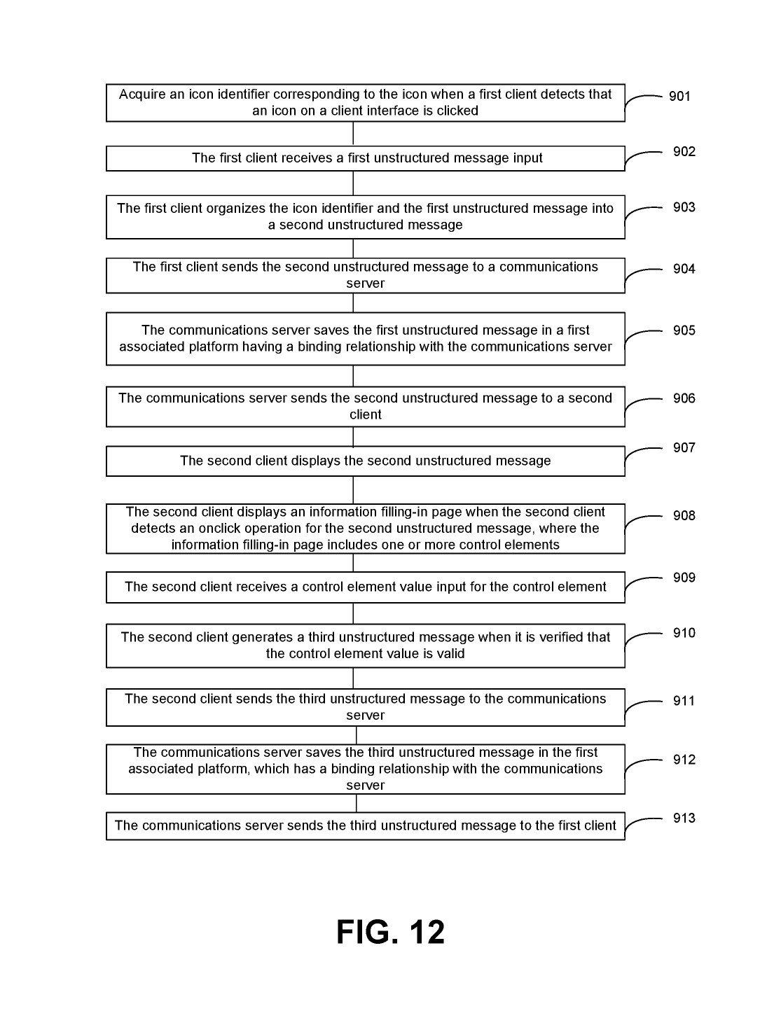

FIG. 12 illustrates a flowchart of a method for processing an unstructured message according to an embodiment of the disclosure.

In Step 901, when a first client detects that an icon on a client interface is clicked, an icon identifier corresponding to the icon is acquired.

In Step 902, the first client receives a first unstructured message input.

In Step 903, the first client organizes the icon identifier and the first unstructured message into a second unstructured message.

In Step 904, the first client sends the second unstructured message to a communications server.

In Step 905, the communications server saves the first unstructured message in a first associated platform having a binding relationship with the communications server, stores the first unstructured message in the first associated platform, and generates a first data identifier corresponding to the first unstructured message.

In Step 906, the communications server sends the second unstructured message to a second client.

In Step 907, the second client displays the second unstructured message.

In Step 908, the second client displays an information fill-in page when an on-click operation for the second unstructured message is detected, where the information fill-in page includes one or more control elements.

In Step 909, the second client receives a control element value input for the control element.

In Step 910, the second client generates a third unstructured message when it is verified that the control element value is valid.

In Step 911, the second client sends the third unstructured message to the communications server.

In Step 912, the communications server saves the third unstructured message in the first associated platform having a binding relationship with the communications server, stores the third unstructured message in the first associated platform, and generates the second data identifier corresponding to the third unstructured message.

In Step 913, the communications server sends the third unstructured message to the first client.

The methods and sequence of steps described and/or illustrated herein are given by way of example only and can be varied as desired. For example, while the steps illustrated and/or described herein may be shown or discussed in a particular order, these steps do not necessarily need to be performed in the order illustrated or discussed. The various example methods described and/or illustrated herein may also omit one or more of the steps described or illustrated herein or include additional steps in addition to those disclosed.

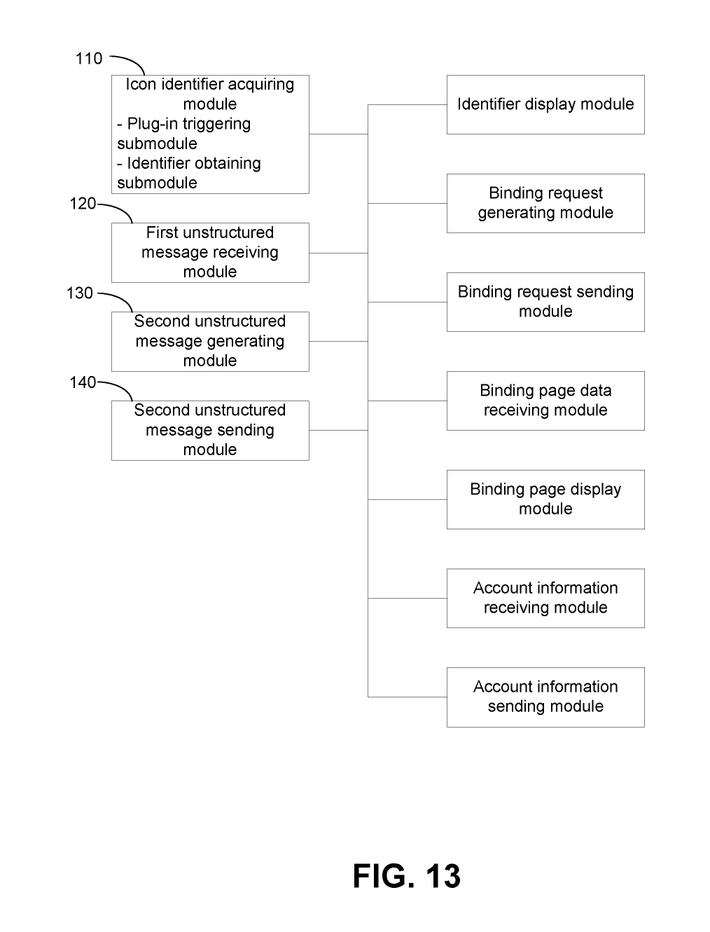

FIG. 13 illustrates a block diagram of a client for processing an unstructured message according to an embodiment of the application, and may specifically include the following modules: an icon identifier acquiring module 110, a first unstructured message receiving module 120, a second unstructured message generating module 130, and a second unstructured message sending module 140. When it is detected that an icon on a client interface is clicked, the icon identifier acquiring module 110 is configured to acquire an icon identifier corresponding to the icon. The first unstructured message receiving module 120 is configured to receive a first unstructured message input by a first user. The second unstructured message generating module 130 is configured to organize the icon identifier and the first unstructured message into a second unstructured message. The second unstructured message sending module 140 is configured to send the second unstructured message to a communications server, where the communications server is configured to then send the second unstructured message to the second client and save the first unstructured message in a first associated platform, which has a binding relationship with the communications server. The first associated platform is a platform configured to store structured information, store the first unstructured message, and generate a first data identifier corresponding to the first unstructured message.

In an embodiment of the present disclosure, the icon identifier acquiring module 110 includes: a plug-in triggering submodule configured to trigger a plug-in corresponding to the icon when it is detected that the first user clicks on the icon on the client interface, and an identifier obtaining submodule configured to obtain an icon identifier corresponding to the plug-in. In an embodiment, the client further includes an identifier display module configured to display the icon identifier in an input box of the first client. In an embodiment, the client also includes: a binding request generating module, a binding request sending module, a binding page data receiving module, a binding page display module, an account information receiving module, and an account information sending module. The binding request generating module is configured to generate a binding request. The binding request sending module is configured to send the binding request to the communications server. The binding page data receiving module is configured to receive binding page data returned by the communications server and corresponding to the binding request. The binding page display module is configured to render the binding page data to output a corresponding binding page. The account information receiving module is configured to receive first bound account information input by the first user in the binding page, where the first bound account information is account information registered by the first user on the first associated platform. The account information sending module is configured to submit the first bound account information to the communications server, where the communications server is configured to generate a binding relationship between account information of the first client and the first bound account information. As an example of embodiments of the disclosure, the first client is a seller client, the second client is a buyer client, the first user is a seller, the first unstructured message is commodity information, the icon identifier is a purchase identifier, the second unstructured message is commodity information carrying the purchase identifier, and the first associated platform is an e-commerce platform.

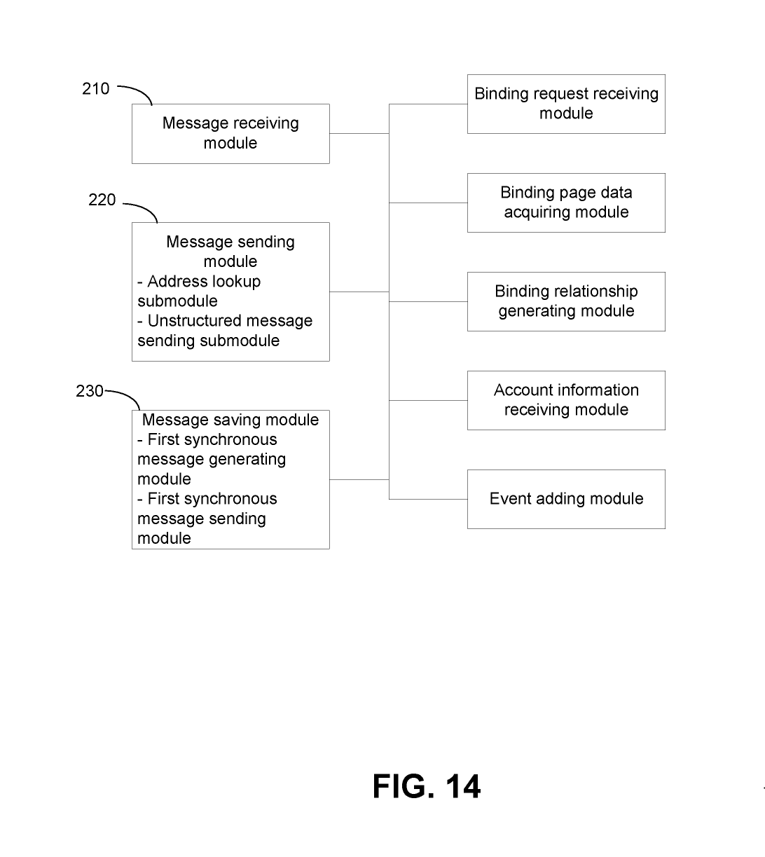

FIG. 14 illustrates a block diagram of a server for processing an unstructured message according to an embodiment of the disclosure, and may specifically include the following modules: a message receiving module 210, a message sending module 220, and a message saving module 230. The message receiving module 210 is configured to receive the second unstructured message sent by the first client, where the second unstructured message includes the icon identifier and the first unstructured message. The message sending module 220 is configured to send the second unstructured message to the second client. The message saving module 230 is configured to save the first unstructured message in the first associated platform having a binding relationship with the communications server, where the first associated platform is a platform configured to store structured information, store the first unstructured message, and generate a first data identifier corresponding to the first unstructured message.

In an embodiment of the present disclosure, the server further includes the following: a binding request receiving module, a binding page data acquiring module, an account information receiving module, and a binding relationship generating module. The binding request receiving module is configured to receive a binding request sent by the first client. The binding page data acquiring module is configured to acquire binding page data corresponding to the binding request and return it to the first client. The account information receiving module is configured to receive first bound account information submitted by the first client for the binding page data, where the first bound account information is account information registered by a first user on the first associated platform for logging onto the first client. The binding relationship generating module is configured to generate a binding relationship between account information of the first client and the first bound account information.

In an embodiment of the present disclosure, the message saving module 230 includes a first synchronous message generating module and a first synchronous message sending module. The first synchronous message generating module is configured to generate a first synchronous message, where the first synchronous message includes the first unstructured message and the first bound account information. The first synchronous message sending module is configured to send the first synchronous message to the first associated platform, where the first associated platform is configured to store the first unstructured message, generate a first data identifier corresponding to the first unstructured message, and generate a binding relationship between the first bound account information and the first data identifier.

In an embodiment of the present disclosure, the second unstructured message carries a user identifier of a second user, and the message sending module 220 includes: an address lookup submodule configured to look up, in a local database, address information of the second user corresponding to the user identifier of the second user, and an unstructured message sending submodule configured to send the second unstructured message to the second client corresponding to the address information of the second user.

In an embodiment of the present disclosure, the server further includes an event adding module configured to add an on-click event for the second unstructured message when it recognizes an icon identifier of the second unstructured message.

As an example of embodiments of the present disclosure, the first client is a seller client, the second client is a buyer client, the first user is a seller user, the second user is a buyer user, the first unstructured message is commodity information, the icon identifier is a purchase identifier, the second unstructured message is commodity information carrying the purchase identifier, and the first associated platform is an e-commerce platform.

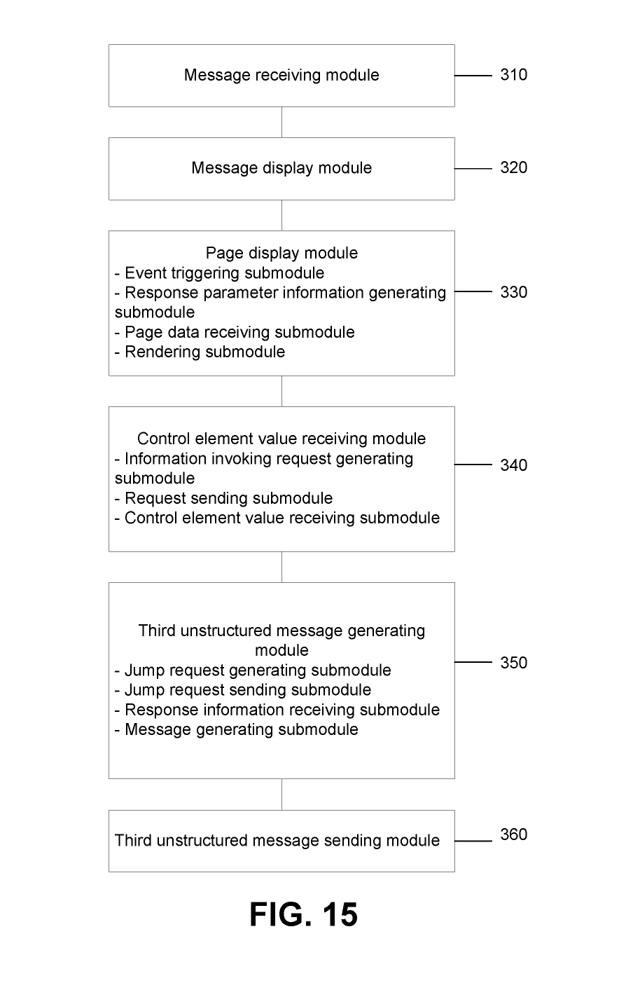

FIG. 15 illustrates a block diagram of a client for processing an unstructured message according to an embodiment of the disclosure, and may include the following modules: a message receiving module 310, a message display module 320, a page display module 330, a control element value receiving module 340, a third unstructured message generating module 350, and a third unstructured message sending module 360. The message receiving module 310 is configured to receive a second unstructured message sent by a communications server, where the second unstructured message includes an icon identifier and a first unstructured message. The message display module 320 is configured to display the second unstructured message. The page display module 330 is configured to display an information fill-in page when an on-click operation for the second unstructured message is detected, where the information fill-in page includes one or more control elements. The control element value receiving module 340 is configured to receive a control element value input for the control element. The third unstructured message generating module 350 is configured to generate a third unstructured message when it is verified that the control element value is valid. The third unstructured message sending module 360 is configured to send the third unstructured message to the communications server, where the communications server is configured to send the third unstructured message to the first client and save the third unstructured message in the first associated platform having a binding relationship with the communications server. The first associated platform is a platform configured to store structured information, store the third unstructured message, and generate a second data identifier corresponding to the third unstructured message.

In an embodiment of the present disclosure, the second unstructured message is added with an on-click event and the page display module 330 includes: an event triggering submodule, a response parameter information generating submodule, a page data receiving submodule, and a rendering submodule. The event triggering submodule is configured to trigger the on-click event when an on-click operation for the second unstructured message is detected. The response parameter information generating submodule is configured to generate response parameter information corresponding to the on-click event and return it to the communications server. The page data receiving submodule is configured to receive data of the information fill-in page sent by the communications server, where the data of the information fill-in page includes one or more control elements. The rendering submodule is configured to render the data of the information fill-in page to display the corresponding information fill-in page.

In an embodiment of the present disclosure, the control element has a control element identifier and the control element value receiving module 340 includes: an information invoking request generating submodule, a request sending submodule, and a control element value receiving submodule. The information invoking request generating submodule is configured to generate an information invoking request, where the information invoking request comprises the control element identifier. The request sending submodule is configured to send the information invoking request to the communications server. The control element value receiving submodule is configured to receive the control element value, returned by the communications server and corresponding to the control element identifier.

In an embodiment of the disclosure, the communications server has a bound second associated platform, and the third unstructured message generating module 350 includes: a jump request generating submodule, a jump request sending submodule, a response information receiving submodule, and a message generating submodule. The jump request generating submodule is configured to generate a jump request of the second associated platform according to the control element value when it is verified that the control element value is valid. The jump request sending submodule is configured to send the jump request to the communications server, where the communications server is configured to jump to the second associated platform according to the jump request, and to receive response information returned by the second associated platform. The second associated platform is configured to process the control element value and return the response information. The response information receiving submodule is configured to receive the response information sent by the communications server according to the jump request. The message generating submodule is configured to generate the third unstructured message when it is determined that the response information is successful response information.

As an example of embodiments of the disclosure, the first client is a seller client, the second client is a buyer client, the first unstructured message is commodity information, the icon identifier is a purchase identifier, the second unstructured message is commodity information carrying the purchase identifier, the information fill-in page is an order fill-in page, the third unstructured message is order completion information, the first associated platform is an e-commerce platform, and the second associated platform is a payment platform.

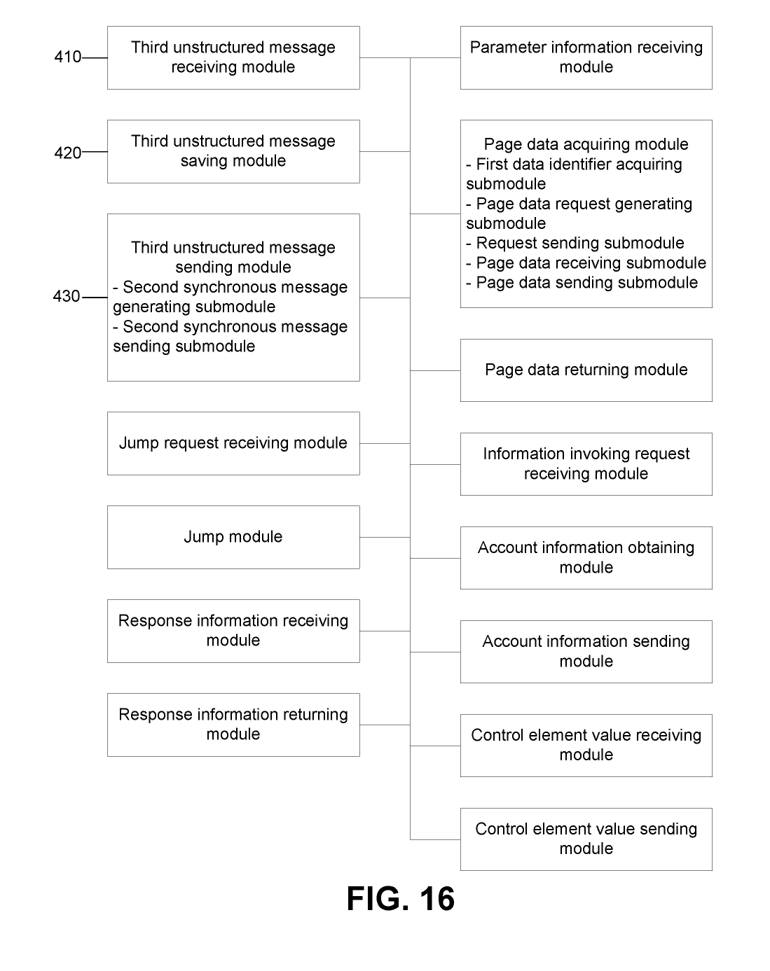

FIG. 16 illustrates a structural block diagram of a server for processing an unstructured message according to an embodiment of the disclosure, and may include the following modules: a third unstructured message receiving module 410, a third unstructured message saving module 420, and a third unstructured message sending module 430. The third unstructured message receiving module 410 is configured to receive a third unstructured message sent by a second client, where the third unstructured message is configured to: display the second unstructured message after the second client receives the second unstructured message; display an information fill-in page after an on-click operation for the second unstructured message is detected; display the information fill-in page which includes one or more control elements; receive a control element value input for the control element; and generate, when it is verified that the control element value is valid, the second unstructured message that includes a first unstructured message and an icon identifier. The third unstructured message saving module 420 is configured to save the third unstructured message in a first associated platform having a binding relationship with the communications server, where the first associated platform is a platform configured to store structured information, store the third unstructured message, and generate a second data identifier corresponding to the third unstructured message. The third unstructured message sending module 430 is configured to send the third unstructured message to a first client.

In an embodiment of the present disclosure, the server further includes: a parameter information receiving module configured to receive response parameter information returned by the second client; a page data acquiring module configured to acquire corresponding data of the information fill-in page according to the response parameter information, where the data of the information fill-in page includes one or more control elements; and a page data returning module, configured to return the data of the information fill-in page to the client.

In an embodiment of the present disclosure, the page data acquiring module includes: a first data identifier acquiring submodule, a page data request generating submodule, a request sending submodule, a page data receiving submodule, and a page data sending submodule. The first data identifier acquiring submodule is configured to acquire a first data identifier corresponding to the first unstructured message. The page data request generating submodule is configured to generate a fill-in page data request according to the first data identifier. The request sending submodule is configured to send the fill-in page data request to the first associated platform, where the first associated platform is configured to generate data of the information fill-in page corresponding to the first data identifier according to preset page generating logic, and return the data of the information fill-in page to the communications server. The page data receiving submodule is configured to receive the data of the information fill-in page returned by the first associated platform and corresponding to the first data identifier. The page data sending submodule is configured to return the data of the information fill-in page to the second client.

In an embodiment of the present disclosure, account information of the second client has second bound account information bound in the first associated platform, and the server further includes: an information invoking request receiving module, an account information obtaining module, an account information sending module, a control element value receiving module, and a control element value sending module. The information invoking request receiving module is configured to receive an information invoking request sent by the second client, where the information invoking request comprises a control element identifier. The account information obtaining module is configured to obtain second bound account information corresponding to an account of the second client. The account information sending module is configured to send the information invoking request and the second bound account information to the first associated platform, where the first associated platform is configured to locate a corresponding data record according to the second bound account information, and look up, from the data record, a control element value corresponding to the control element identifier. The control element value receiving module is configured to receive the control element value returned by the first associated platform and corresponding to the control element identifier. The control element value sending module is configured to return the control element value to the second client.

In an embodiment of the present disclosure, the third unstructured message sending module 430 includes a second synchronous message generating submodule and a second synchronous message sending submodule. The second synchronous message generating submodule is configured to generate a second synchronous message, where the second synchronous message includes the third unstructured message and the second bound account information. The second synchronous message sending submodule is configured to send the second synchronous message to the first associated platform, where the first associated platform is configured to store the third unstructured message, generate a second data identifier corresponding to the third unstructured message, and generate a binding relationship between the second bound account information and the second data identifier.

In an embodiment of the present disclosure, the server further includes: a jump request receiving module, a jump module, a response information receiving module, and a response information returning module. The jump request receiving module is configured to receive a jump request of a second associated platform sent by the second client. The jump module is configured to jump to the second associated platform according to the jump request, where the second associated platform is configured to process the control element value and return response information. The response information receiving module is configured to receive the response information returned by the second associated platform. The response information returning module is configured to send the response information to the second client.

As an example of embodiments of the present disclosure, the first client is a seller client, the second client is a buyer client, the first unstructured message is commodity information, the icon identifier is a purchase identifier, the second unstructured message is commodity information carrying the purchase identifier, the information fill-in page is an order fill-in page, the third unstructured message is order completion information, the first associated platform is an e-commerce platform, and the second associated platform is a payment platform.

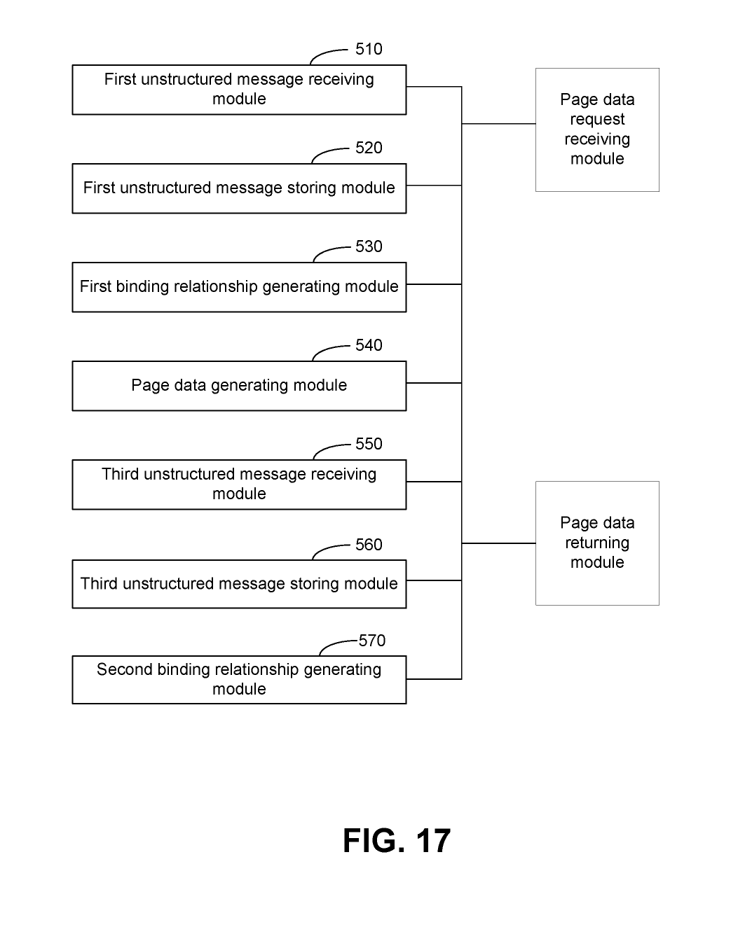

FIG. 17 illustrates a block diagram of a platform for processing an unstructured message according to an embodiment of the disclosure, and may include the following modules: a first unstructured message receiving module 510, a first unstructured message storing module 520, a first binding relationship generating module 530, a page data generating module 540, a third unstructured message receiving module 550, a third unstructured message storing module 560, and a second binding relationship generating module 570. The first unstructured message receiving module 510 is configured to receive a first unstructured message sent by a communications server. The first unstructured message is a message received by the communications server from a first client, where the first client has account information, and the account information of the first client has first bound account information bound in the first associated platform. the first unstructured message storing module 520 is configured to store the first unstructured message and generate a first data identifier corresponding to the first unstructured message. The first binding relationship generating module 530 is configured to generate a binding relationship between the first bound account information and the first data identifier. The page data generating module 540 is configured to generate data of the information fill-in page according to the first data identifier; in an embodiment, the page data generating module is configured to generate the data of the information fill-in page corresponding to the first data identifier according to a preset page generating logic. The third unstructured message receiving module 550 is configured to receive a third unstructured message sent by a communications server, where the third unstructured message is data of the information fill-in page acquired by the communications server as well as a message generated for the data of the information fill-in page from the second client after the data of the information fill-in page is sent to a second client. The third unstructured message storing module 560 is configured to store the third unstructured message and generate a second data identifier corresponding to the third unstructured message. The second binding relationship generating module 570 is configured to generate a binding relationship between the second bound account information and the second data identifier.

In an embodiment of the present disclosure, the platform further includes: a page data request receiving module, and a page data returning module. The page data request receiving module is configured to receive a fill-in page data request sent by the communications server, where the fill-in page data request includes a first data identifier. The page data returning module is configured to return the data of the information fill-in page to the communications server.

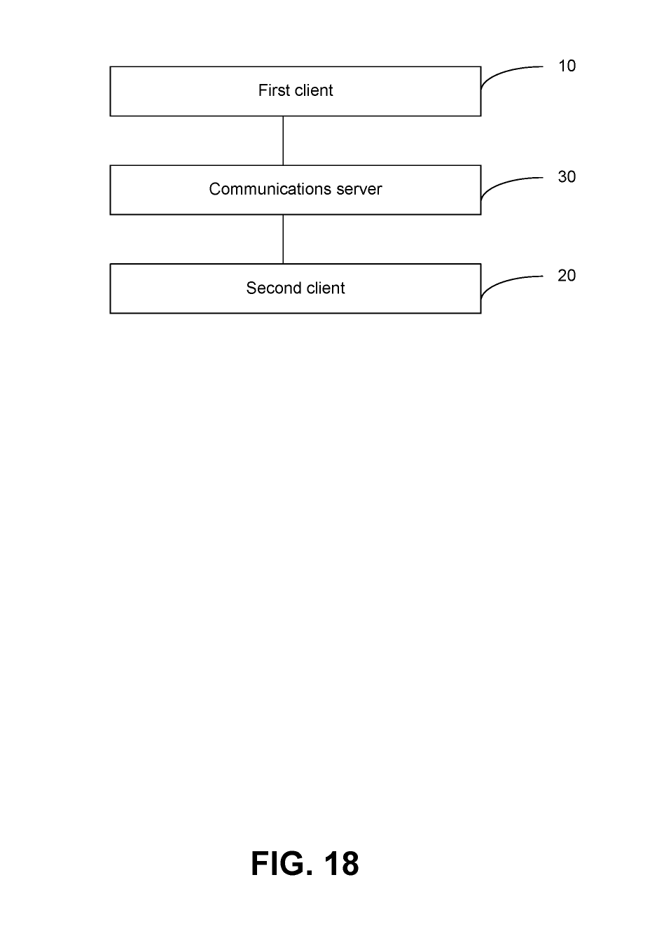

FIG. 18 illustrates a block diagram of a system for processing an unstructured message according to an embodiment of the disclosure. The system includes a first client 10, a second client 20, and a communications server 30. In an embodiment, the first client 10 includes: an icon identifier acquiring module, a first unstructured message receiving module, a second unstructured message generating module, and a second unstructured message sending module. When it is detected that an icon on a client interface is clicked, the icon identifier acquiring module is configured to acquire an icon identifier corresponding to the icon. The first unstructured message receiving module is configured to receive a first unstructured message input by a first user. The second unstructured message generating module is configured to organize the icon identifier and the first unstructured message into a second unstructured message. The second unstructured message sending module is configured to send the second unstructured message to the communications server, where the communications server is configured to send the second unstructured message to the second client and save the first unstructured message in a first associated platform, which has a binding relationship with the communications server. The first associated platform is a platform configured to store structured information, store the first unstructured message, and generate a first data identifier corresponding to the first unstructured message.

In an embodiment, the second client 20 includes: a message receiving module, a message display module, a page display module, a control element value receiving module, a third unstructured message generating module, and a third unstructured message sending module. The message receiving module is configured to receive a second unstructured message sent by a communications server, where the second unstructured message includes an icon identifier and a first unstructured message. The message display module is configured to display the second unstructured message. The page display module is configured to display an information fill-in page when an on-click operation for the second unstructured message is detected, where the information fill-in page includes one or more control elements. The control element value receiving module is configured to receive a control element value input for the control element. The third unstructured message generating module is configured to generate a third unstructured message when it is verified that the control element value is valid. The third unstructured message sending module is configured to send the third unstructured message to the communications server, where the communications server is configured to send the third unstructured message to the first client and save the third unstructured message in the first associated platform, which has a binding relationship with the communications server. The first associated platform is a platform configured to store structured information, store the third unstructured message, and generate a second data identifier corresponding to the third unstructured message.

In an embodiment, the communications server 30 includes: a message receiving module, a message sending module, a message saving module, a third unstructured message receiving module, a third unstructured message saving module, and a third unstructured message sending module. The message receiving module is configured to receive a second unstructured message sent by a first client, where the second unstructured message includes an icon identifier and a first unstructured message. The message sending module is configured to send the second unstructured message to a second client. The message saving module is configured to save the first unstructured message in a first associated platform having a binding relationship with the communications server, where the first associated platform is a platform configured to store structured information, store the first unstructured message, and generate a first data identifier corresponding to the first unstructured message. The third unstructured message receiving module is configured to receive a third unstructured message sent by the second client. The third unstructured message saving module is configured to save the third unstructured message in a first associated platform having a binding relationship with the communications server, where the first associated platform is a platform configured to store structured information, store the third unstructured message, and generate a second data identifier corresponding to the third unstructured message. The third unstructured message sending module is configured to send the third unstructured message to a first client.

FIG. 19 is a block diagram of an example of a computing device 1910 capable of implementing embodiments according to the present disclosure. The device 1910 broadly includes any single or multi-processor computing device or system capable of executing computer-readable instructions, such as those described in conjunction with FIGS. 1, 5, 6, 10, 11 and 12. That is, the device 1910 can be implemented as a client for processing an unstructured message, a server for processing an unstructured message, a platform for processing an unstructured message, or a system for processing an unstructured message. In its most basic configuration, the device 1910 may include at least one processing circuit (e.g., the processor 1914) and at least one non-volatile storage medium (e.g., the memory 1916).

The processor 1914 generally represents any type or form of processing unit or circuit capable of processing data or interpreting and executing instructions. In certain embodiments, the processor 1914 may receive instructions from a software application or module. These instructions may cause the processor 1914 to perform the functions of one or more of the example embodiments described and/or illustrated herein.

The system memory 1916 generally represents any type or form of volatile or non-volatile storage device or medium capable of storing data and/or other computer-readable instructions. Examples of system memory 1916 include, without limitation, RAM, ROM, flash memory, or any other suitable memory device. Although not required, in certain embodiments the node 1910 may include a volatile memory unit in addition to a non-volatile storage unit. In an embodiment, the system memory 1916 includes a cache 1920.

The device 1910 may also include one or more components or elements in addition to the processor 1914 and the system memory 1916. For example, the device 1910 may include a memory device, an input/output (I/O) device, and a communication interface 1918, each of which may be interconnected via a communication infrastructure. The communication interface 1918 broadly represents any type or form of communication device or adapter capable of facilitating communication between the device 1910 and one or more other devices.

The device 1910 can execute an application 1940 that allows it to perform operations (e.g., the operations of FIGS. 1, 5, 6, 10, 11 and 12). A computer program containing the application 1940 may be loaded into the device 1910. For example, all or a portion of the computer program stored on a computer-readable medium may be stored in the memory 1916. When executed by the processor 1914, the computer program can cause the processor to perform and/or be a means for performing the functions of the example embodiments described and/or illustrated herein. Additionally or alternatively, the example embodiments described and/or illustrated herein may be implemented in firmware and/or hardware.

The embodiments in this specification are described in a progressive manner. Each embodiment is focused on differences from other embodiments, with cross-referencing available for identical or similar parts among different embodiments. Those skilled in the art will realize that an embodiment among the embodiments of the present disclosure may be provided as a method, an apparatus, or a computer program product. Therefore, embodiments of the present disclosure may use forms of a full hardware embodiment, a full software embodiment, or an embodiment combining both software and hardware aspects. Furthermore, embodiments of the present disclosure may use forms of computer program products implemented on one or more computer storage media (including, but not limited to, a magnetic disk memory, a CD-ROM, an optical memory, or the like), which includes computer program code.

In an embodiment, the computer equipment includes one or more CPUs, input-output interfaces, network interfaces, and memories. A memory may include a volatile memory in a computer-readable medium, a RAM, and/or a non-volatile memory, such as a ROM or a flash RAM. A memory is an example of a computer-readable medium. A computer-readable medium includes a non-volatile medium, a volatile medium, a mobile medium, or an immobile medium, which may implement information storage by means of any method or technology. Information may be a computer-readable instruction, a data structure, a module of a program, or other data. Examples of computer storage media include, but are not limited to, a phase change RAM (PRAM), a static RAM (SRAM), a dynamic RAM (DRAM), other types of RAM, a ROM, an EEPROM, a flash memory or other memory technologies, a CD-ROM, DVD or other optical memories, a cartridge magnetic tape, a magnetic tape or magnetic disk memory, or other magnetic storage devices or any other non-transmission media, which may be configured to store information that can be accessed by a computing device. As defined herein, computer-readable media do not include transitory media such as, for example, modulated data signals and carriers.

Embodiments of the disclosure are described with reference to flowcharts and/or block diagrams of the method in the embodiments of the disclosure, a terminal device (system), and a computer program product. It should be understood that each flowchart and/or block in the flowcharts and/or block diagrams and a combination thereof may be implemented by means of computer program instructions. These computer program instructions may be provided for a general-purpose computer, a special-purpose computer, an embedded processor, or processors of other programmable data processing terminal equipment to generate a machine, so as to generate an apparatus configured to implement designated functions in one or more steps of a flowchart and/or one or more blocks of a block diagram by means of instructions executed by a computer or a processor of other programmable data processing terminal equipment. These computer program instructions may also be stored in a computer-readable memory that can guide a computer or other programmable data processing terminal equipment to work in a particular way, so that the instructions stored in the computer-readable memory generate a manufactured product, including a command device that implements the designated functions in one or more flows of a flowchart and/or one or more blocks of a block diagram. These computer program instructions may also be loaded on a computer or other programmable data processing terminal equipment to execute a series of operating steps on the computer or other programmable terminal equipment to generate treatments implemented by the equipment, so that instructions executed on the computer or other programmable terminal equipment provide steps configured to implement designated functions in one or more flows of a flowchart and/or one or more blocks of a block diagram.

While the foregoing disclosure sets forth various embodiments using specific block diagrams, flowcharts, and examples, each block diagram component, flowchart step, operation, and/or component described and/or illustrated herein may be implemented, individually and/or collectively, using a wide range of hardware, software, or firmware (or any combination thereof) configurations. In addition, any disclosure of components contained within other components should be considered as examples because many other architectures can be implemented to achieve the same functionality.

The process parameters and sequence of steps described and/or illustrated herein are given by way of example only and can be varied as desired. For example, while the steps illustrated and/or described herein may be shown or discussed in a particular order, these steps do not necessarily need to be performed in the order illustrated or discussed. The various example methods described and/or illustrated herein may also omit one or more of the steps described or illustrated herein or include additional steps in addition to those disclosed.

While various embodiments have been described and/or illustrated herein in the context of fully functional computing systems, one or more of these example embodiments may be distributed as a program product in a variety of forms, regardless of the particular type of computer-readable media used to actually carry out the distribution. The embodiments disclosed herein may also be implemented using software modules that perform certain tasks. These software modules may include script, batch, or other executable files that may be stored on a computer-readable storage medium or in a computing system. These software modules may configure a computing system to perform one or more of the example embodiments disclosed herein. One or more of the software modules disclosed herein may be implemented in a cloud computing environment. Cloud computing environments may provide various services and applications via the Internet. These cloud-based services (e.g., software as a service, platform as a service, infrastructure as a service, etc.) may be accessible through a Web browser or other remote interface. Various functions described herein may be provided through a remote desktop environment or any other cloud-based computing environment.

Although embodiments of the disclosure have been described, those skilled in the art may make additional alterations and modifications on these embodiments as soon as they know the basic creative concept. Therefore, the appended claims are intended to be interpreted as comprising those embodiments and all alterations and modifications falling within the scope of embodiments of the application.

Finally, a relational term (such as “a first” or “a second”) is merely intended to separate one entity or operation from another entity or operation instead of requiring or hinting that any practical relation or sequence exists among these entities or operations. Furthermore, terms such as “comprise,” “include,” or other variants thereof are intended to cover a non-exclusive “comprise” so that a process, a method, a commodity, or a terminal device comprising a series of elements not only includes these elements, but also includes other elements not listed explicitly, or also includes inherent elements of the process, the method, the commodity, or the terminal device. In the case of no additional restrictions, elements restricted by a sentence “include a . . . ” do not exclude the fact that additional identical elements may exist in a process, a method, a commodity, or a terminal device of these elements.

The above describes in detail a method, a client, a server, and a platform for processing an unstructured message provided by the application. Elaboration of the principles and the implementation manners of the application is made by using specific examples herein, and the description of the foregoing embodiments is merely intended to assist in understanding the method of the application and the core concept thereof; also, those of ordinary skill in the art may change, in accordance with the concept of the application, a concrete implementation and the scope of application. In conclusion, the specification shall be not interpreted as restricting the scope of the application.

What is claimed is:

1. A method for processing an unstructured message, the method comprising:
acquiring an icon identifier corresponding to an icon on a client interface in response to a first client detecting that the icon is clicked;
receiving a first unstructured message inputted by a first user;
organizing the icon identifier and the first unstructured message into a second unstructured message; and
sending the second unstructured message to a communications server, wherein the communications server is configured to send the second unstructured message to a second client and save the first unstructured message in a first associated platform having a binding relationship with the communications server, and wherein the first associated platform is a platform configured to store structured information, store the first unstructured message, and generate a first data identifier corresponding to the first unstructured message.

2. The method of claim 1, further comprising:
generating a binding request;
sending the binding request to the communications server;
receiving binding page data, returned by the communications server, corresponding to the binding request;
rendering the binding page data to output a corresponding binding page;
receiving first bound account information inputted by the first user in the binding page, wherein the first bound account information is account information registered by the first user on the first associated platform; and
submitting the first bound account information to the communications server, wherein the communications server is configured to generate a binding relationship between account information of the first client and the first bound account information.

3. The method of claim 1, wherein the first client is a seller client, the second client is a buyer client, the first user is a seller, the first unstructured message is commodity information, the icon identifier is a purchase identifier, the second unstructured message is commodity information carrying the purchase identifier, and the first associated platform is an e-commerce platform.

4. A method for processing an unstructured message, the method comprising:
receiving, by a communications server, a second unstructured message sent by a first client, wherein the second unstructured message comprises an icon identifier and a first unstructured message;
sending the second unstructured message to a second client; and
saving the first unstructured message in a first associated platform having a binding relationship with the communications server, wherein the first associated platform is a platform configured to store structured information, store the first unstructured message, and generate a first data identifier corresponding to the first unstructured message.

5. The method of claim 4, wherein before the step of saving the first unstructured message in a first associated platform having a binding relationship with the communications server, the method further comprises:
receiving, by the communications server, a binding request sent by the first client;
acquiring binding page data corresponding to the binding request and returning it to the first client;
receiving first bound account information submitted by the first client for the binding page data, wherein the first bound account information is account information registered by a first user on the first associated platform for logging onto the first client; and
generating a binding relationship between account information of the first client and the first bound account information.

6. The method of claim 5, wherein the step of saving the first unstructured message in a first associated platform having a binding relationship with the communications server comprises:
generating a first synchronous message, wherein the first synchronous message comprises the first unstructured message and the first bound account information; and
sending the first synchronous message to the first associated platform, wherein the first associated platform is configured to store the first unstructured message, generate a first data identifier corresponding to the first unstructured message, and generate a binding relationship between the first bound account information and the first data identifier.

7. The method of claim 4, wherein the second unstructured message carries a user identifier of a second user, and the step of sending the second unstructured message to a second client comprises:
looking up, in a local database, by the communications server, address information of the second user corresponding to the user identifier of the second user; and
sending the second unstructured message to the second client corresponding to the address information of the second user.

8. The method of claim 4, wherein before the step of sending the second unstructured message to a second client, the method further comprises:
adding an on-click event for the second unstructured message in response to recognizing the icon identifier of the second unstructured message.

9. A method for processing an unstructured message, comprising:
receiving, by a second client, a second unstructured message sent by a communications server, wherein the second unstructured message comprises an icon identifier and a first unstructured message;
displaying the second unstructured message;
displaying an information fill-in page in response to detecting an on-click operation for the second unstructured message, wherein the information fill-in page comprises a control element;
receiving a control element value for the control element;
generating a third unstructured message in response to verification that the control element value is valid; and
sending the third unstructured message to a communications server, wherein the communications server is configured to send the third unstructured message to a first client and to save the third unstructured message in a first associated platform having a binding relationship with the communications server; and wherein the first associated platform is a platform configured to store structured information, store the third unstructured message, and generate a second data identifier corresponding to the third unstructured message.

10. The method of claim 9, wherein the second unstructured message is added with an on-click event, and the step of displaying an information fill-in page in response to detecting an on-click operation for the second unstructured message comprises:
triggering the on-click event in response to detecting the on-click operation for the second unstructured message;
generating response parameter information corresponding to the on-click event and returning it to the communications server;
receiving data of the information fill-in page sent by the communications server, wherein the data of the information fill-in page comprises the control element; and
rendering the data of the information fill-in page to display the corresponding information fill-in page.

11. The method of claim 9, wherein the control element has a control element identifier, and the step of receiving a control element value inputted for the control element comprises:
generating an information invoking request, wherein the information invoking request comprises the control element identifier;
sending the information invoking request to the communications server; and
receiving the control element value, returned by the communications server, corresponding to the control element identifier.

12. The method of claim 9, wherein the communications server has a bound second associated platform, and the step of generating a third unstructured message when it is verified that the control element value is valid comprises:
generating a jump request of the second associated platform according to the control element value when it is verified that the control element value is valid;
sending the jump request to the communications server, wherein the communications server is configured to jump to the second associated platform according to the jump request and receive response information returned by the second associated platform, and wherein the second associated platform is configured to process the control element value and return the response information;
receiving the response information sent by the communications server according to the jump request; and
generating the third unstructured message if it is determined that the response information is successful response information.

13. The method of claim 12, wherein the first client is a seller client, the second client is a buyer client, the first unstructured message is commodity information, the icon identifier is a purchase identifier, the second unstructured message is commodity information carrying the purchase identifier, the information fill-in page is an order fill-in page, the third unstructured message is order completion information, the first associated platform is an e-commerce platform, and the second associated platform is a payment platform.

14. A method for processing an unstructured message, the method comprising:
receiving, by a communications server, a third unstructured message sent by a second client, wherein the third unstructured message is configured to: display the second unstructured message after the second client receives the second unstructured message; display an information fill-in page after detecting an on-click operation for the second unstructured message; display the information fill-in page comprising a control element; receive a control element value inputted for the control element; and generate, in response to verification that the control element value is valid, the second unstructured message that comprises a first unstructured message and an icon identifier;
saving the third unstructured message in a first associated platform having a binding relationship with the communications server, wherein the first associated platform is a platform configured to store structured information, store the third unstructured message, and generate a second data identifier corresponding to the third unstructured message; and
sending the third unstructured message to a first client.

15. The method of claim 14, wherein before the step of receiving the third unstructured message sent by the second client, the method further comprises:
receiving response parameter information returned by the second client;
acquiring corresponding data of the information fill-in page according to the response parameter information, wherein the data of the information fill-in page comprises the control element; and
returning the data of the information fill-in page to the second client.

16. The method of claim 15, wherein the step of acquiring corresponding data of the information fill-in page according to the response parameter information comprises:
acquiring, by the communications server, a first data identifier corresponding to the first unstructured message;
generating a fill-in page data request according to the first data identifier;
sending the fill-in page data request to the first associated platform, wherein the first associated platform is configured to generate the data of the information fill-in page corresponding to the first data identifier according to preset page generating logic, and return the data of the information fill-in page to the communications server;
receiving the data of the information fill-in page, returned by the first associated platform, corresponding to the first data identifier; and
returning the data of the information fill-in page to the second client.

17. The method of claim 15, wherein account information of the second client has second bound account information in the first associated platform, and after the step of returning the data of the information fill-in page to the second client, the method further comprises:
receiving an information invoking request sent by the second client, wherein the information invoking request comprises a control element identifier;
obtaining the second bound account information corresponding to an account of the second client;
sending the information invoking request and the second bound account information to the first associated platform, wherein the first associated platform is configured to locate a corresponding data record according to the second bound account information, and look up, from the data record, a control element value corresponding to the control element identifier;
receiving the control element value, returned by the first associated platform, corresponding to the control element identifier; and
returning the control element value to the second client.

18. The method of claim 17, wherein the step of saving the third unstructured message in a first associated platform having a binding relationship with the communications server comprises:
generating a second synchronous message, wherein the second synchronous message comprises the third unstructured message and the second bound account information; and
sending the second synchronous message to the first associated platform, wherein the first associated platform is configured to store the third unstructured message, generate a second data identifier corresponding to the third unstructured message, and generate a binding relationship between the second bound account information and the second data identifier.

19. The method of claim 14, wherein before the step of receiving the third unstructured message sent by the second client, the method further comprises:
receiving a jump request, of a second associated platform, sent by the second client;
jumping to the second associated platform according to the jump request, wherein the second associated platform is configured to process the control element value and return response information;
receiving the response information returned by the second associated platform; and
sending the response information to the second client.

20. The method of claim 19, wherein the first client is a seller client, the second client is a buyer client, the first unstructured message is commodity information, the icon identifier is a purchase identifier, the second unstructured message is commodity information carrying the purchase identifier, the information fill-in page is an order fill-in page, the third unstructured message is order completion information, the first associated platform is an e-commerce platform, and the second associated platform is a payment platform.

21. A server for processing an unstructured message, the server comprising:
a message receiving module, configured to receive a second unstructured message sent by a first client, wherein the second unstructured message comprises an icon identifier and a first unstructured message;
a message sending module, configured to send the second unstructured message to a second client; and
a message saving module, configured to save the first unstructured message in a first associated platform having a binding relationship with a communications server, wherein the first associated platform is a platform configured to store structured information, store the first unstructured message, and generate a first data identifier corresponding to the first unstructured message.
